(19) United States
(12) Patent Application Publication
(10) Pub. No.: US 2005/0242136 A1
(43) Pub. Date: Nov. 3, 2005

(54) Infant carrier

(75) Inventors: Yuko Moriguchi, Saitama-shi (JP); Sakiko Minami, Saitama-shi (JP)

Correspondence Address: YOUNG & THOMPSON, 745 SOUTH 23RD STREET, 2ND FLOOR, ARLINGTON, VA, 22202, US

(73) Assignee: COBI CORPORATION, TOKYO (JP)

(21) Appl. No.: 11/117,446

(22) Filed: Apr. 29, 2005

(30) Foreign Application Priority Data
Apr. 30, 2004 (JP) 2004-136761
Apr. 30, 2004 (JP) 2004-136773
Apr. 30, 2004 (JP) 2004-136780
Apr. 30, 2004 (JP) 2004-136783

(51) Int. Cl. A61G 1/00

(52) U.S. Cl. 224/160

(57) ABSTRACT

An infant carrier has an infant carrier main body having a pair of shoulder belts to be mounted around the shoulders of a user, and a vertical holding seat to be mounted on the infant carrier main body so as to hold an infant in a vertical holding condition. The back sides of the pair of the shoulder belts are provided with curves in directions that they approach each other, and joining elements for joining together the shoulder belts is provided at the vertex positions of the curves.

### BACKGROUND OF THE INVENTION

The present invention relates to an infant carrier. More specifically, the present invention relates to an infant carrier having a structure in which a pair of shoulder belts are mounted on the shoulders of a user, an infant carrier capable of holding an infant in a vertical holding condition with a vertical holding seat mounted on an infant carrier main body, an infant carrier for joining a protective portion for an infant with an infant carrier main body through a head support and an infant carrier in which a bib can be attached to an infant carrier main body or the vertical holding seat.

As a conventional infant carrier, Japanese Patent Application Laid-Open (JP-A) No. 2000-245581 and JP-A No. 2002-282097 have disclosed an infant carrier in which a bag-like infant carrier main body for accommodating an infant is provided on a pair of shoulder belts to be mounted on the shoulder of a user and a vertical holding seat is integrally mounted on the infant carrier main body so as to hold an infant in a vertical holding condition. In this infant carrier, a head protective portion is provided at the top end of the vertical holding seat and this head protective portion is connected to the shoulder belts through a head support. However, the conventional infant carriers have the following problems.

In the above-described infant carrier, when an infant is held or carried vertically on the front side of the user, the vertical holding seat is pulled forward by the weight of the infant. For this reason, the largest part of the load is applied to particularly the back side of the shoulder belt. In the cross-type infant carrier in which the shoulder belts cross on the back side, a load applied to the back side is distributed evenly from the center of the user's back to the shoulders in order to reduce the burden on the user. Contrary to this, other type shoulder belts other than the cross type cannot distribute the load over the entire back of the user and their load distribution function is inferior to the cross type.

The conventional infant carriers use clamps such as buckles or hooks for connecting the infant carrier main body and the vertical holding seat to each other, and in order to enhance the safety, it is necessary to provide a single joining section with plural clamps to prepare for a damage of one of the joining devices. Further, to keep the infant from falling from the side of the vertical holding seat, it is also necessary to place a hold belt around the waist of the infant and connect this to the infant carrier main body. However, if such a measure is taken, the quantity of the clamps increases so that it takes labor and time to engage or disengage those clamps thereby worsening convenience of use.

If in the conventional infant carrier, its head protective portion is so constructed to be foldable downward to the outside of the vertical holding seat, the head support is twisted and thus in connection with the folding back of the head protective portion, it is necessary to reattach the head support by turning it back with respect to the shoulder belt. To eliminate this inconvenience, it has been considered joining the head support and the shoulder belt through a pair of relatively rotatable clamps. However, if the clamps are constructed to be rotatable, the head support enters internally due to the twisting action according to the folding back of the head protective portion so that there is a possibility that comfort of the infant may be deteriorated.

In the above-mentioned infant carrier, when an infant is carried in his or her backward facing condition (in face-to-face condition), the shoulder belt near the chest is contaminated with saliva from the infant's mouth. When the infant is carried facing forward, the head protective portion is folded down, and the folding part is contaminated with saliva. To protect from such contamination, it is necessary to put a cloth such as gauze between the shoulder belt and the infant or on the head protective portion and however, only if the cloth is put on, there is a possibility that it may fall off or peel off, so that it may become useless.

### SUMMARY OF THE INVENTION

The first object of the present invention is to provide an infant carrier which is so constructed that its shoulder belts are not crossed on the back of a user but joined together so as to distribute a load applied to the back of the user appropriately thereby reducing the burden applied to the user.

To achieve the first object, according to the first aspect of the present invention, there is provided an infant carrier main body having a pair of shoulder belts to be mounted around the shoulders of a user; and a vertical holding seat to be mounted on the infant carrier main body so as to hold an infant in a vertical holding condition, wherein the back sides of the pair of the shoulder belts are provided with curves in directions that they approach each other, and joining means for joining together the shoulder belts is provided at the vertex positions of the curves.

According to the infant carrier of the first aspect, since the back sides of the shoulder belts are curved so that their vertex portions are joined with the joining means, the back sides of the shoulder belts can be run along the back of the user like the cross type, and a load is distributed at a good balance from the center portion of the back of the user to the shoulders, thereby reducing the burden on the user.

In the infant carrier according to the first aspect, the joining means is permitted to be so constructed that the joining is released by pushing operation from an internal face side of the infant carrier main body to an external face side thereof. Using such joining means enables the release operation of the joining means to be executed more easily as compared with joining means of type in which the joining is released by gripping the operation portions paired by upper and lower ones.

In the infant carrier according to the first aspect, the joining means is permitted to include a pair of joining devices mounted on each of the pair of the shoulder belts and capable of being joined and released, and the pair of the joining devices are capable of rotating relatively in the vertical direction in joining condition thereof. If the joining devices can rotate, the shoulder belts can be fitted to users having many physical features by changing the degree of opening condition of the shoulder belts with respect to the joining means corresponding to the physical feature of the user.

In an infant carrier according to a preferred embodiment of the first aspect, the joining means includes a pair of joining devices mounted on each of the pair of the shoulder belts and capable of being joined and released, one of the pair of the joining devices is provided with an operation portion deformable elastically from the internal face side of the infant carrier main body to the external face side while the other joining device is provided with a pair of wall portions disposed on the internal face side and the external face side of the infant carrier main body such that they oppose each other so as to form a concave portion in which the operation portion is to be inserted, the wall portion on the internal face side of the pair of the wall portions is provided with a passage hole communicating with the concave portion and the operation portion is provided with a hooking portion capable of being hooked on an inside wall of the passage hole.

According to the above embodiment, the operation portion of one joining device is engaged with the internal face side through a passage hole in the other joining device and by operating that operation portion from the internal face side of the shoulder belt to the external face side, the hooking portion is released from the inside wall of the passage hole and consequently, the joining of the joining devices can be released.

According to the above embodiment, the hooking portion is permitted to be capable of rotating along the inside wall of the passage hole. Consequently, the joining devices can rotate relatively in the joining condition and the shoulder belts can be fitted to users having diversified physical features by changing the degree of opening condition of the shoulder belts with respect to the joining means corresponding to the physical feature of the user.

Further, the other joining device may be provided with a stopper for limiting the rotation range of the one joining device. By limiting the rotation range with the stopper, the shoulder belts can be prevented from being opened too much.

Of the pair of the wall portions, the wall portion on the external face side may be projected in an opening direction of the concave portion with respect to the wall portion on the internal face side. In this case, the operation portion can be struck to the wall portion on the external face side from the internal face side of the shoulder belt and with this as a guide, and the operation portion can be inserted into the concave portion in the other joining device. Therefore, the joining operation of the joining devices can be achieved easily.

Further, the wall portion on the internal face side may be provided with a tapered face which increases an interval between the pair of the wall portions as it goes in an opening direction of the concave portion. Providing such a tapered face expands the opening of the concave portion so that the operation portion can be inserted into the concave portion more easily.

The second object of the present invention is to provide an infant carrier capable of improving convenience of a use by reducing labor and time for engaging or disengaging the clamps with the safety in mind.

To achieve the second object, according to the second aspect of the present invention, there is provided an infant carrier comprising an infant carrier main body to be mounted on a user and a vertical holding seat to be mounted on the infant carrier main body so as to hold an infant in a vertical holding condition, wherein the vertical holding seat is provided with a pair of holding portions which are placed on the sides of the infant while the front ends thereof are joined to the infant carrier main body, the front end of each of the holding portions is provided with a seat side clamp having a single unit clamp main body and plural hooking portions formed integrally with the clamp main body in conditions in which they are departed from each other in the vertical direction and the infant carrier main body includes main body side clamps, each of which has the same number of receiving portions as that of the hooking portions, the receiving portions being capable of engaging each of the plural hooking portions of the seat side clamp.

According to the infant carrier of the second aspect, plural hooking portions at the front ends of respective holding portions are engaged with receiving portions of each shoulder belt so as to join the holding portions with the shoulder belt, even if any of the hooking portions or the receiving portions is damaged, the joining between the holding portion and the shoulder belt is maintained by the remaining hooking portion and receiving portion. Therefore, high safety is secured. Further, because the plural hooking portions are provided on a single clamp main body, those hooking portions can be engaged with or disengaged from the receiving portions simultaneously and consequently, it takes less labor and time to join the holding portion with the shoulder belt or release the joining as compared with a case of engaging or disengaging the plural hooking portions with/from the receiving portions individually. As a result, labor and time for engaging and disengaging the clamp can be reduced thereby improving convenience of use. Further, because the seat side clamp can be straightened relatively long in the vertical direction of the holding portion, the holding portion can be joined with the shoulder belt in a relatively wide range in the vertical direction, so that gaps generated on the sides of the infant are narrowed to thereby enhance the safety. In this case, if the holding portion is removed from the shoulder belt, the side portions of the vertical holding seat are opened widely and as a result, the infant can be loaded or unloaded easily. Further, when mounting the holding portion to the shoulder belt by separating the hooking portions and the receiving portion vertically, nothing but bringing the holding portion up to a condition in which each hooking portion is located just above the corresponding receiving portion is needed, so that burden on operation of the holding portion is small.

In the infant carrier of the second aspect, the clamp main body of the seat side clamp may comprise a lock which engages a lock receiver of each of the main body side clamps when each of the hooking portions engages the receiving portions so as to disable disengagement between the hooking portions and the receiving portions and lock releasing means for deforming the lock elastically in a direction that the lock is disengaged from the lock receiver by an unlocking operation to a predetermined operation portion. According to this embodiment, by engaging the lock with the lock receiver, the clamp main body of the seat side clamp and the main body side clamp can be joined together and as a result, the plural hooking portions provided on the clamp main body can be kept in a condition disabling disengagement from the receiving portion simultaneously. Further, if unlocking operation is carried to the operation portion of the unlocking means, engagement between the plural hooking portions and the receiving portions can be released simultaneously. Therefore, the disengagement between the holding portions and the shoulder belt can be achieved more easily as compared with the case where each hooking portion is equipped with a locking mechanism.

Further, according to the above embodiment, in each of the main body side clamps, each of the receiving portions may be provided on a common base and the lock receivers may be provided on the base. By providing the receiving portion and the lock receiver on the common base, labor and time upon mounting the main body side clamp on the shoulder belt are reduced. Further, there is no possibility that the position relation between the receiver and the lock may be deflected. Further, load applied to the plural receiving portions can be distributed in a wide range of the shoulder belt.

In the infant carrier of the second aspect, the front end of each holding portion may be provided with a cover for covering the seat side clamp. According to this embodiment, a contact between an infant accommodated in the vertical holding seat and the seat main body is prevented to thereby improve comfort for the infant.

According to the above embodiment, the cover may comprise an external cover portion for covering the seat clamp from an external face side of the vertical holding seat and an internal cover portion for covering the seat side clamp from an internal face side of the vertical holding seat while the internal cover portion may be longer than the external cover portion. Consequently, exposure of the seat side clamp to the internal face side of the vertical holding seat is suppressed securely and the hooking portion can be seen from the external face side of the vertical holding seat, so that the operability when the holding portion and shoulder belt are joined can be improved.

Further, the internal cover portion may include a core material for preventing the internal cover portion from being turned up. According to this embodiment, possibility that the front end of the holding portion may be turned up so that the seat side clamp is exposed to the internal face side of the vertical holding seat can be eliminated.

According to the above embodiment having the lock, a front end of each holding portion is provided with a cover for covering the seat side clamp and a portion of the cover opposing the operation portion has no core material so that the portion of the cover is formed as a low stiffness portion. According to this embodiment, while exposure of the seat side clamp is prevented with the cover, the lock can be released by operating the operation portion from outside that cover.

Further, the cover may be provided with an identification mark indicating a position of the operation portion. Even if the seat side clamp is covered with the cover by the identification mark, which portion of the cover should be operated can be distinguished easily.

In the infant carrier of the second aspect, an outer face side of the holding portion may be provided with a grip for the user to hold the holding portion. According to this embodiment, the user can attach the seat side clamp to the main body side clamp by gripping the grip, thereby improving the operability. In this case, the grip is formed into a belt traversing the holding portion vertically and an upper end portion and a lower end portion of the grip are sewed to the holding portion, and the sewing lines may be extended obliquely upward toward the front end of the holding portion. If the sewing lines are provided obliquely, the holding portion can be raised up more easily by inserting the fingers in between the grip and the external face of the holding portion from the proximal portion of the holding portion toward the front end.

The third object of the present invention is to provide an infant carrier in which the head support does not need to be reattached when folding back the head protective portion and twisting of the head support inward is suppressed to improve the comfort around the head portion of the infant.

To achieve the third object, according to the third aspect of the present invention, there is provided an infant carrier comprising: an infant carrier main body to be mounted on the user; a vertical holding seat capable of being attached to the infant carrier main body so as to hold an infant in a vertical holding condition, and having on a top end thereof a head protective portion for supporting a head portion of the infant so as to be foldable downward; and a head support which is projected sideway from the head protective portion and both ends thereof are capable of being joined to the infant carrier main body, wherein the head support includes a supporting portion extended from the head protective portion downward so as to be curved in an arch shape and connecting portions extended from both ends of the supporting portion so as to be bent to the outer peripheral side of the supporting portion, and on an external face side of each of the connecting portions of the head support and each of head support mounting positions of the infant carrier main body, there are provided clamps capable of being joined to and released from each other and rotating relatively when the clamps are joined together.

According to the infant carrier of the third aspect, since the head support and each shoulder belt are joined with a pair of the clamps which can rotate relatively, it is not necessary to reattach the head support to the shoulder belts by turning back both ends thereof when the head protective portion is folded back. Further, since the supporting portion of the head support is curved into an arch shape, the supporting portion of the head support is projected outward to secure a large space around the head portion of the infant when the external face sides of the connecting portions are connected to the shoulder belts in conditions in which the head protective portion is straightened. Since the connecting portions provided on both sides of the supporting portion are extended such that they are bent to the outer peripheral side of the curved supporting portion, the degree of the twisting of the supporting portion inward when the head protective portion is folded back is reduced more as compared with a case where the head support is entirely curved into the arch shape. Consequently, comfort of the infant is maintained highly.

In the infant carrier of the third aspect, a bending line may be provided on each boundary between the supporting portion of the head support and each of the connecting portions. According to this embodiment, when the head protective portion is folded back, the supporting portion is folded back outward with respect to the connecting portions of the head support so as to reduce the twisting of the supporting portion to the internal face side of the vertical holding seat more. In the meantime, the bending lines can be formed by sewing together cloth of the head support in a thickness direction thereof.

In the infant carrier of the third aspect, each of the clamps provided on the connecting portions of the head support may be fixed on each of the connecting portions on both sides thereof across a rotation center line of each clamp. By attaching the clamps to the connecting portions, deflection of the clamps on the head support side inward with respect to the rotation center can be prevented. Consequently, the twisting of the supporting portion inward can be suppressed.

In the infant carrier of the third aspect, lock means may be provided between each of the clamps provided on each of the connecting portions of the head support and each of the head support mounting positions of the infant carrier main body, the and the lock means is capable of capturing the both clamps with respect to a rotation direction of the clamps at each of a position suitable for a condition in which the head protective portion is straightened upward and a position suitable for a condition in which the head protective portion is folded back downward. By providing such locking means, an excessive play between the clamps in the rotation direction can be suppressed so that the posture of the head support in a condition in which the head protective portion is straightened and in a condition in which it is folded back can be stabilized. In the meantime, as the locking means, the convex and concave portions can be provided in opposing faces of the clamps provided on each of the connecting portions of the head support and each of the head support mounting positions of the infant carrier main body. Due to these concave and convex portions, the rotation between the clamps can be captured appropriately with a simple structure.

In the infant carrier of the third aspect, the supporting portion of the head support may be provided with length adjusting means. By providing the length adjusting means on the supporting portion, there is such an advantage that the length adjusting means is not an obstacle to the rotation of the connecting portions. Further, on the supporting portion, there may be provided, as the length adjusting means, a deformable portion foldable in a length direction of the supporting portion and a pair of hooks disposed on both sides of the deformable portion and capable of being joined to and released from each other. According to this embodiment, the length of the head support can be changed with a relatively simple structure. Further, if the head support is constructed as a separate member capable of being inserted into and removed from the head protective portion, and the length adjusting means may be provided at a portion hidden by the head protective portion of the head support. In this case, there is no possibility that the length adjusting means may collide with the infant because it is hidden within the head protective portion and any part such as the length adjusting belt and hook is not exposed from the surrounding of the head protective portion, thereby improving the appearance quality.

The fourth object of the present invention is to provide an infant carrier capable of fixing a bib at an appropriate position when an infant is carried in his or her backward facing direction or in his or her forward facing direction and further to provide a bib suitable for such an infant carrier.

To achieve the fourth object, according to the fourth aspect of the present invention, there is provided an infant carrier comprising: an infant carrier main body to be mounted on a user; a vertical holding seat capable of being attached to the infant carrier main body so as to hold an infant in a vertical holding condition, and having on a top end thereof a head protective portion for supporting a head portion of the infant so as to be foldable downward; a head support which is projected sideway from the head protective portion and both ends thereof are capable of being joined to the infant carrier main body; and a bib capable of being selectively mounted on the infant carrier main body or the head protective portion, wherein the bib includes a bib main body for receiving saliva of the infant; a pocket capable of being mounted on the vertical holding seat so as to cover the head protective portion and having opening portions allowing the head support to pass through on both sides thereof; upper clamps for attaching both ends of an upper portion of the bib main body to the infant carrier main body; and lower clamps for attaching a lower portion of the bib main body to the infant carrier main body or the vertical holding seat selectively.

To achieve the fourth object of the present invention, there is provided a bib comprising: a bib main body for receiving saliva of an infant; a pocket capable of being mounted on a vertical holding seat of the infant carrier so as to cover a head protective portion of the vertical holding seat and having opening portions allowing a head support of the vertical holding seat to pass through on both sides thereof; upper clamps for attaching both ends of an upper portion of the bib main body to an infant carrier main body of the infant carrier; and lower clamps for attaching a lower portion of the bib main body to the infant carrier main body or the vertical holding seat selectively.

According to the infant carrier and the bib of the fourth aspect, when an infant is carried in the backward facing direction, the both ends of the upper portion of the bib main body are attached to the infant carrier main body with the upper clamps of the bib and the bottom of the bib main body is attached to the infant carrier main body with the lower clamps. Consequently, the upper and lower portions of the bib are fixed to the infant carrier main body so that the bib can be prevented from being deflected or turned up. On the other hand, when the infant is carried in the forward facing direction, with the head protective portion straightened, the bib main body is hung in the head protective portion while the pocket is placed over the head protective portion and then, the head support is pulled out of the opening portions of that pocket. Further, the lower portion of the bib is attached to the vertical holding seat using the lower clamps. Consequently, the upper and lower portions of the bib can be attached to the vertical holding seat securely thereby preventing it from being deflected or turned up. Since the pocket is placed over the head protective portion, when the head protective portion is folded back, the folded portion is covered by the bib so that the head protective portion is protected securely.

In the infant carrier of the fourth aspect, as the upper clamps, a pair of push type hooks may be provided on both sides of the upper portion of the bib main body and the infant carrier main body may have hooks which clamp with the hooks on the bib side. By using such hooks, the upper portion of the bib can be attached to the infant carrier main body simply and securely.

The infant carrier main body may be provided with a pair of shoulder belts to be placed on the shoulders of the user and the hooks of the infant carrier main body may be provided on the front sides of the shoulder belts, respectively. Consequently, the upper portion of the bib can be clamped securely near the chest portion of the shoulder belts.

The infant carrier may further comprise a pair of clamp strings capable of being joined to or released from each other as the lower clamps. If the clamp strings are used, the lower portion of the bib can be attached securely by placing the clamp strings around the infant carrier and the vertical holding seat and joining them together.

### BRIEF DESCRIPTION OF THE DRAWINGS

FIG. 1 is a perspective view showing the use condition of an infant carrier according to one embodiment of the present invention;

FIG. 2 is a perspective view showing a condition in which the vertical holding seat is opened half;

FIG. 3 is a front view of the infant carrier;

FIG. 4 is a rear view of the infant carrier;

FIG. 5 is a diagram showing a condition in which the shoulder belts are mounted on a user as viewed from the back side of the user;

FIG. 6 is a perspective view showing a condition in which the male buckle and female buckle of a rotary buckle device are joined together;

FIG. 7 is a perspective view showing a condition in which the joining of the male buckle and the female buckle is released;

FIG. 8 is a front view of the rotary buckle device;

FIG. 9 is a rear view of the rotary buckle device;

FIG. 10 is a sectional view taken along the line X-X of FIG. 8;

FIG. 11 is a sectional view taken along the line XI-XI of FIG. 8;

FIG. 12 is a diagram showing a condition in which the male buckle is rotated with respect to the female buckle;

FIG. 13 is a sectional view showing a condition in which the buckle of the rotary buckle device is mounted on the shoulder belt;

FIG. 14 is a diagram showing an operation for releasing the joining of the rotary buckle device;

FIG. 15 is a diagram showing a status in which the male buckle of the rotary buckle device is joined with the female buckle;

FIG. 16 is a diagram showing a joining portion for joining an adjust belt for adjustment of the shoulder belt length with the bottom end on the rear side of the shoulder belt;

FIG. 17 is a perspective view of the joining condition of the side buckle device;

FIG. 18 is a perspective view of joining release condition of the side buckle device;

FIG. 19 is a plan view of the side buckle device;

FIG. 20 is a front view of the side buckle device;

FIG. 21 is a sectional view taken along the line XXI-XXI of FIG. 19;

FIG. 22 is a sectional view taken along the line XXII-XXII of FIG. 20;

FIG. 23 is a sectional view taken along the line XXIII-XXIII of FIG. 20;

FIG. 24 is a diagram for connecting the hold portion of the vertical holding seat to the shoulder belt with the side buckle device;

FIG. 25 is a diagram showing the relation between the buckle cover and the side buckle device provided at the front end of the hold portion;

FIG. 26 is a diagram showing the mounting portion of the male buckle at the front end of the hold portion as viewed from the outside face of the hold portion;

FIG. 27 is a diagram showing the relation among the male buckle, the buckle cover and the core material;

FIG. 28 is a diagram showing a condition in which an identification mark is provided on the buckle cover thereof;

FIG. 29 is a diagram showing the use condition of the head support;

FIG. 30 is a diagram showing the use condition of the head support as viewed from other direction;

FIG. 31 is a diagram showing a condition in which the head protective portion of the vertical holding seat is folded back shallowly;

FIG. 32 is a diagram showing a condition in which the head protective portion of the vertical holding seat is folded back deeply;

FIG. 33 is a front view of the head support;

FIG. 34 is a rear view of the head support;

FIG. 35 is a plan view of the male buckle which constitutes the rotary buckle device for attaching the head support;

FIG. 36 is a plan view of the female buckle which constitutes the rotary buckle device for attaching the head support;

FIG. 37 is a sectional view showing a condition in which the male buckle and female buckle of the rotary buckle device are joined together;

FIG. 38 is a front view of bib;

FIG. 39 is a rear view of the bib;

FIG. 40 is a diagram showing a condition in which the bib is attached to the head protective portion of the vertical holding seat; and

FIG. 41 is a diagram showing a condition in which the head protective portion is folded back from the state shown in FIG. 40 downward.

### DETAILED DESCRIPTION OF THE PREFERRED EMBODIMENTS

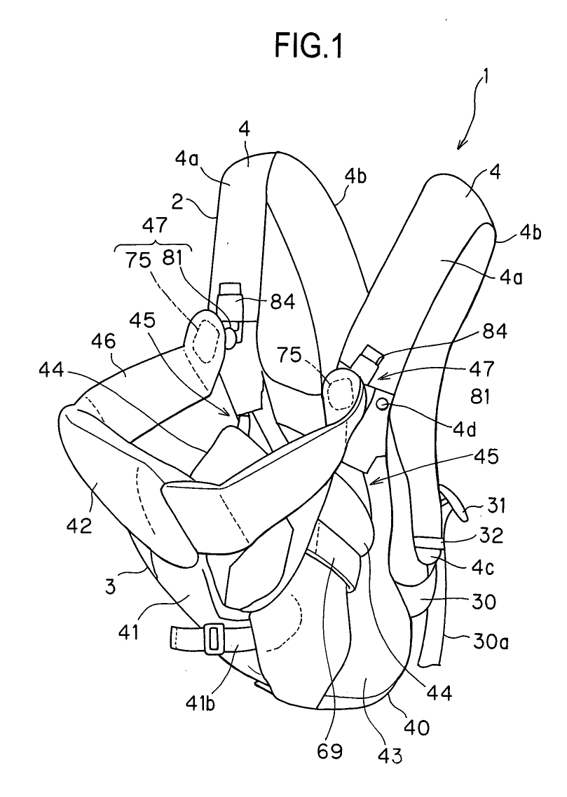

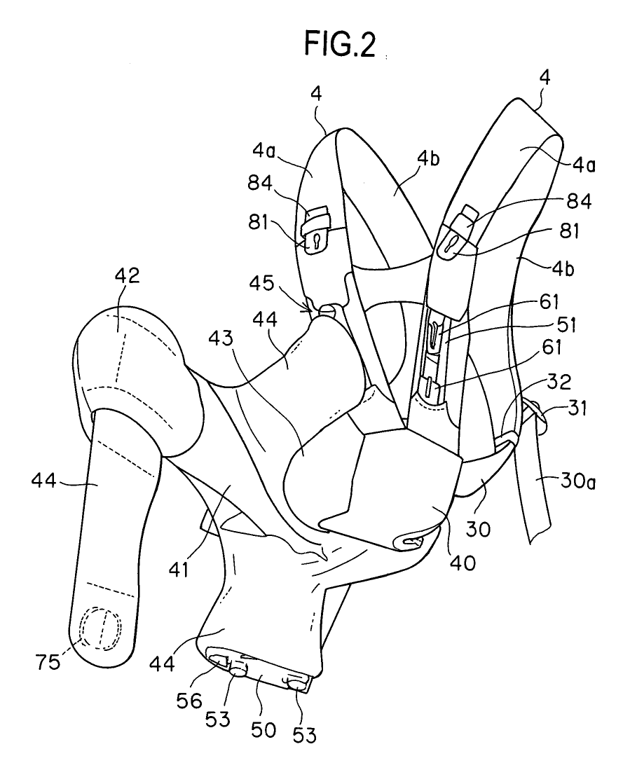

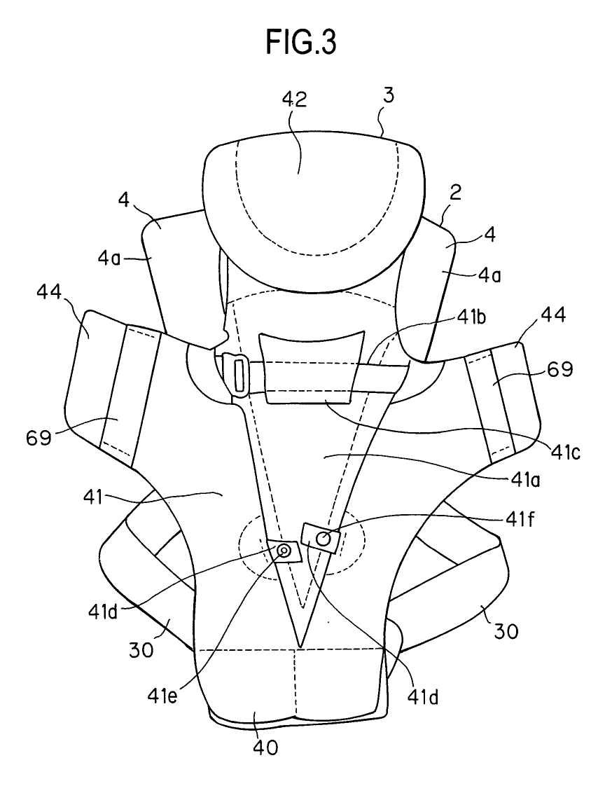

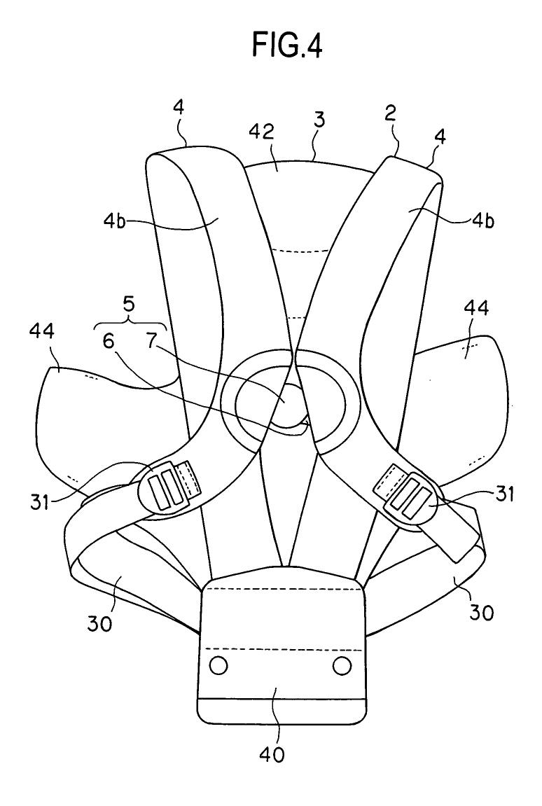

FIG. 1 is a perspective view showing the use condition of the infant carrier according to one embodiment of the present invention, FIG. 2 is a perspective view showing a condition in which the vertical holding seat is opened half, FIG. 3 is a front view of the infant carrier 1, and FIG. 4 is a rear view of the infant carrier 1. As evident from these Figures, the infant carrier 1 comprises an infant carrier main body 2 to be mounted on a user (for example, a parent) and a vertical holding seat 3 which is detachable to the infant carrier main body 2. The infant carrier main body 2 comprises a pair of shoulder belts 4 to be mounted on the shoulders of the user. The vertical holding seat 3 is used for holding an infant in a vertical holding condition and attached to the front sides 4a of the shoulder belts 4. The infant carrier main body 2 may allow another attachment such as a lateral holding seat to be attached thereto instead of the vertical holding seat 3, however, the infant carrier 1 of this embodiment is so constructed as a vertical holding dedicated device for holding the infant in a forward facing condition or a rearward facing condition by attaching the vertical holding seat 3 to the front sides 4a of the shoulder belts 4.

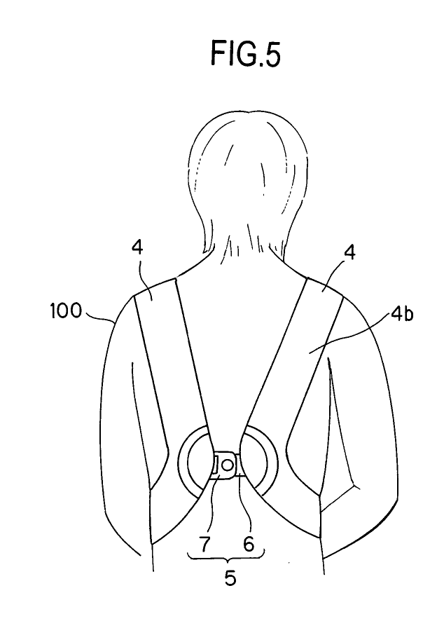

As shown in FIGS. 4 and 5, the back sides 4b of the shoulder belts 4 are provided with curves which approach each other. The vertexes of those curves substantially align with the center portion of the back of the user and a rotary buckle device 5 acting as joining means for joining the shoulder belts 4 is provided there. The rotary buckle device 5 comprises a male buckle 6 and female buckle 7 as paired joining devices which are mounted on the paired shoulder belts 4 and can be engaged and disengaged. By joining these buckles 6 and 7, the back sides 4b of the paired shoulder belts 4 run along the back of a user 100 (FIG. 5) like the cross type shoulder belts in which a pair of shoulder belts cross in the back of the user 100 so as to distribute a load applied on the user 100 appropriately. When the vertical holding seat 3 is mounted on the front sides 4a of the shoulder belts 4, the infant carrier 1 is pulled forward by the weight of an infant applied to the vertical holding seat 3, if the backsides 4b of the paired shoulder belts 4 is constructed with a structure similar to the cross type, the load applied from the center of the back of the user 100 to the shoulder is distributed evenly thereby reducing a load applied to the user 100. Although it is desirable to set the width of the back side 4b on each shoulder belt 4 as large as possible in order to enhance the load distribution effect, if the width of each shoulder belt 4 is too large, the shoulder belt 4 may not fit to the physical feature of the user 100. From this viewpoint, it is preferable to set the width of the shoulder belt 4 in a range of 60 mm-70 mm.

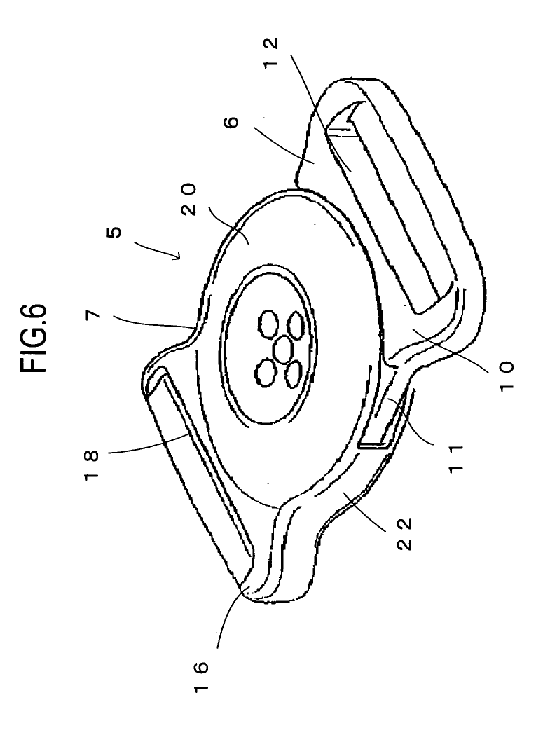

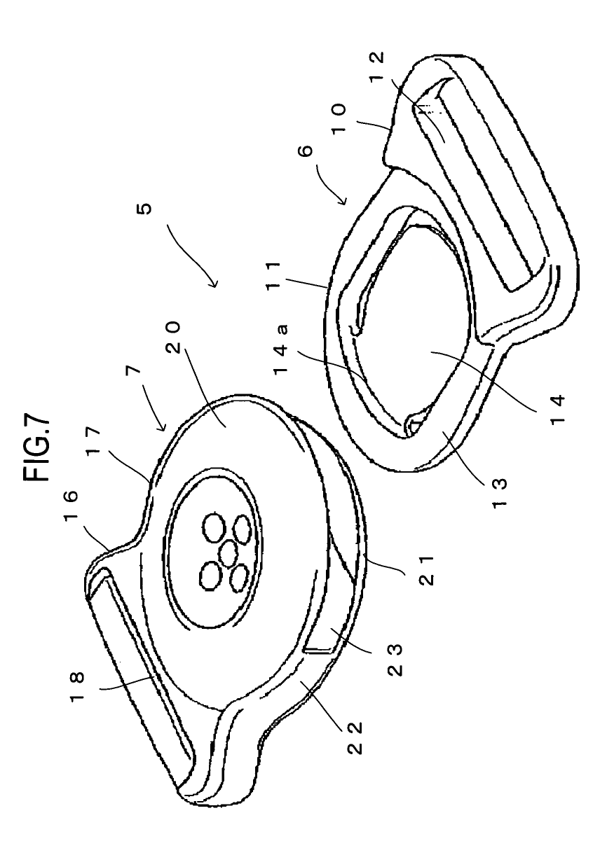

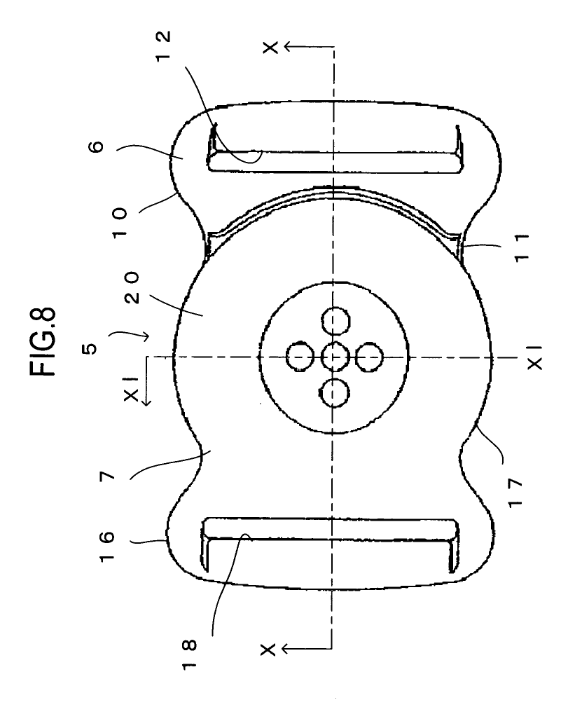

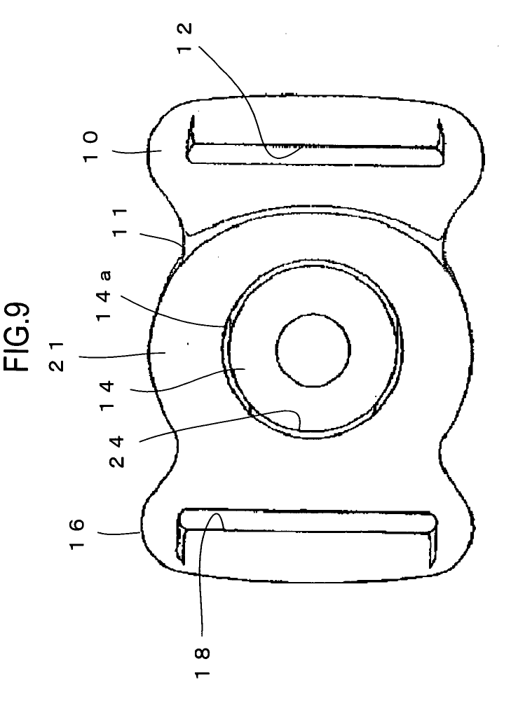

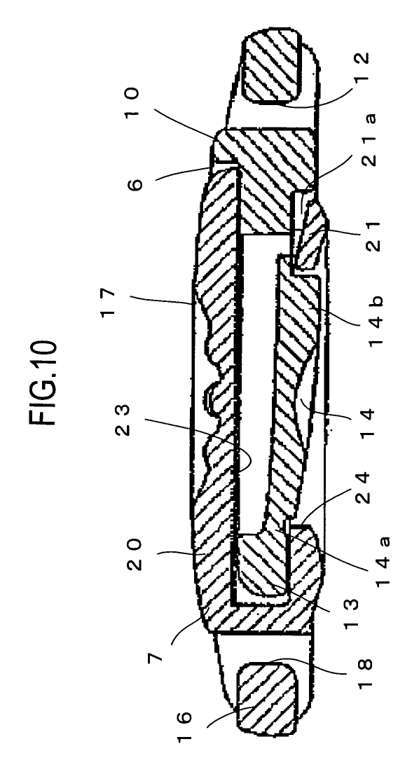

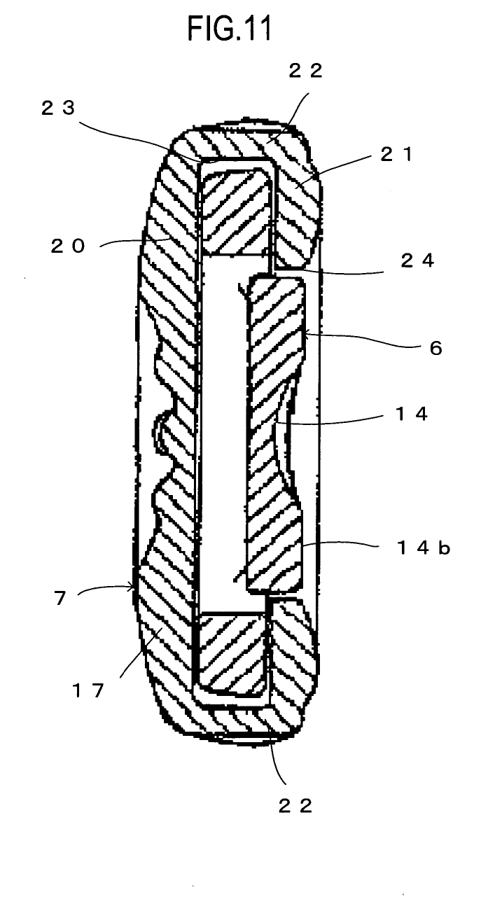

The detail of the rotary buckle device 5 will be described. FIG. 6 is a perspective view showing a condition in which the male buckle 6 and female buckle 7 of the rotary buckle device 5 are joined together, and FIG. 7 is a perspective view showing a condition in which the joining of the male buckle 6 and the female buckle 7 is released. Further, FIG. 8 is a front view of the rotary buckle device 5, FIG. 9 is a rear view of the rotary buckle device 5, FIG. 10 is a sectional view taken along the line X-X of FIG. 8, and FIG. 11 is a sectional view taken along the line XI-XI of FIG. 8. As shown in these Figures, the male buckle 6 has a base 10 and a tang 11 projected from the base 10. The base 10 has a belt passage hole 12 for attaching the male buckle 6 to one of the shoulder belts 4. The tang 11 includes a ring portion 13 formed integrally with the base 10 and an operation portion 14 which is joined to the internal periphery of the ring portion 13 through a proximal portion 14a. The operation portion 14 is elastically deformable in the thickness direction of the male buckle 6 (direction perpendicular to paper in FIG. 8) with the proximal portion 14a as a pivot. As evident from FIG. 9, the operation portion 14 is provided with a circular hooking portion 14b. The hooking portion 14b is formed in the shape of a wedge whose height decreases gradually as it approaches the proximal portion 14a. In the meantime, the male buckle 6 is formed integrally of resin as raw material.

On the other hand, the female buckle 7 has a base 16 and a socket 17 extended from the base 16. The base 16 has a belt passage hole 18 for attaching the female buckle 7 to the other shoulder belt 4. As evident from FIGS. 10 and 11, the socket 17 has a pair of wall portions 20 and 21 opposing each other in the thickness direction of the female buckle 7 (direction perpendicular to the paper in FIG. 8) and a pair of side walls 22 which connect those wall portions 20 and 21. A concave portion 23 which accepts the tang 11 of the male buckle 6 is formed inside these wall portions 20 and 21 and the side walls 22. Further, a circular through hole 24, which communicates with the concave portion 23, is formed in the wall portion 21 on the rear side of the female buckle 7. When the tang 11 of the male buckle 6 is inserted into the concave portion 23, as shown in FIG. 9, the hooking portion 14b is fitted to the through hole 24, so that as shown in FIG. 10, the hooking portion 14b of the operation portion 14 is hooked on the inside wall of the through hole 24, thereby disabling the male buckle 6 from being pulled out of the female buckle 7. If engagement between the hooking portion 14b and the inside wall of the through hole 24 is released by pressing the operation portion 14, the male buckle 6 can be pulled out of the female buckle 7 so as to release the joining of the rotary buckle device 5. Meanwhile, the female buckle 7 is also formed integrally of resin.

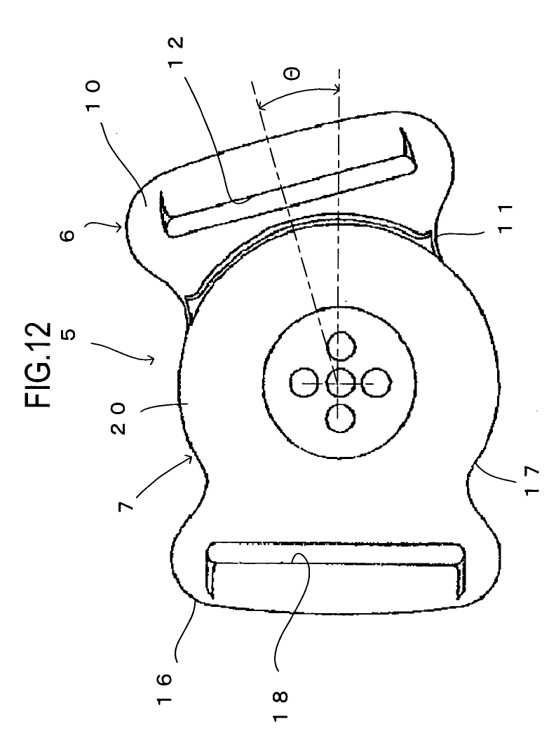

In the state that the male buckle 6 and the female buckle 7 are joined together (the state that the hooking portion 14b is hooked on the inside wall of the through hole 24), the hooking portion 14b can rotate along the inside wall of the through hole 24. Therefore, as shown in FIG. 12, the male buckle 6 can rotate relative to the female buckle 7 around the hooking portion 14b. Consequently, the pair of the shoulder belts 4 can rotate around the center CP of the through hole 24. Consequently, the degree of opening of each of the back sides 4b of the shoulder belts 4 changes depending on a difference in the physical feature of the user so that the shoulder belts 4 can be fitted to users having various physical features.

The rotation of the male buckle 6 relative to the female buckle 7 is allowed in a range where the tang 11 of the male buckle 6 is brought into contact with each side wall 22. Therefore, the pair of the side walls 22 functions as a stopper for restricting the rotation range of the male buckle 6. If the rotation range of the male buckle 6 is larger than necessary, the shoulder belts 4 are opened too much so that there is a possibility that stability upon mounting may be deteriorated and if the rotation range is short, its adjustment function corresponding to the physical feature is lost. From this viewpoint, the rotation angle θ of the male buckle 6 relative to the female buckle 7, more specifically the maximum rotation angle θ of one side with respect to a state in which both the buckles 6 and 7 are aligned on line is preferred to be limited in a range of 10°-20°.

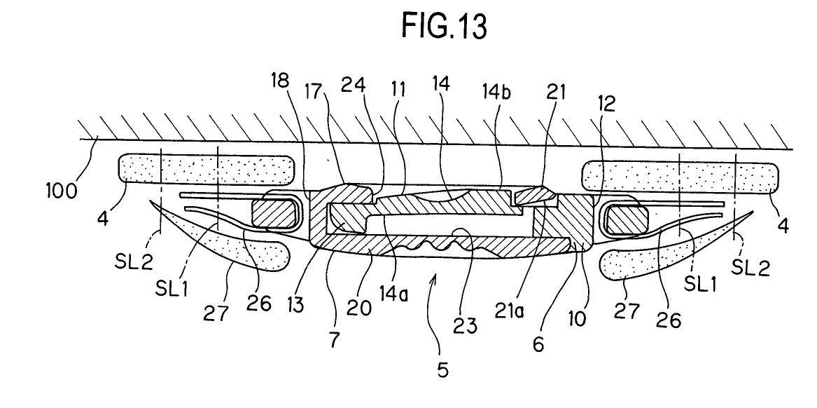

FIG. 13 is a sectional view showing a condition in which the buckles 6 and 7 of the rotary buckle device 5 is mounted on the shoulder belts 4. The buckles 6 and 7 are fixed to the shoulder belts 4 by sewing both end portions of the buckle fixing belts 26 inserted through the belt passage holes 12 and 18 on sewing lines SL1 in conditions in which they overlap the outside faces of the shoulder belts 4. At this time, the female buckle 7 is attached such that the wall portion 21 provided with the through hole 24 is directed to the inside face (side opposing the user) of the shoulder belt 4 and the male buckle 6 is also attached to the shoulder belt 4 in its matching direction. Buckle covers 27 are sewed to the buckle fixing belts 26 and those buckle covers 27 are sewed to the shoulder belts 4 on sewing lines SL2. In the meantime, the sewing lines SL1 are preferred to be set as near the buckles 6 and 7 as possible.

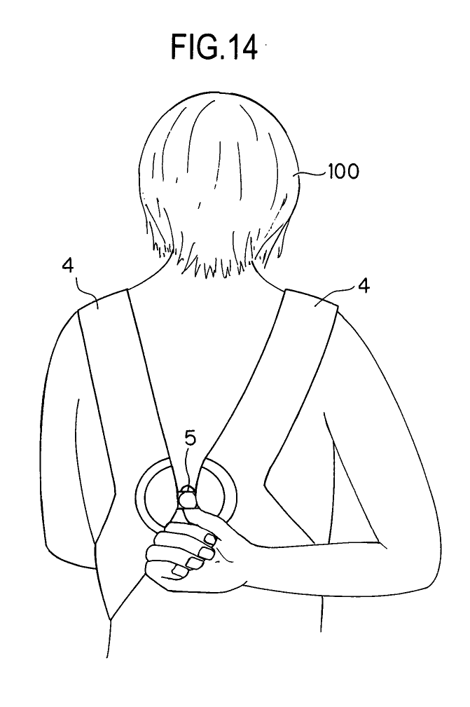

When the buckles 6 and 7 are fixed on the shoulder belts 4 in the above-described direction, to release the joining of the buckles 6 and 7, the user 100 inserts its finger or thumb into the inner side of the shoulder belt 4 and pushes the operation portion 14 (hooking portion 14b) of the male buckle 6 outward as shown in FIG. 14. Therefore, as compared with a structure in which the operation portion for releasing the joining is provided on the top and bottom portions of the buckle and the joining is released by the user gripping the operation portion, the user 100 can release the joining of the buckles 6 and 7 relatively easily. Further, the operation portion 14 is directed to the inner side and the buckles 6 and 7 overlap on the outer sides of the shoulder belts 4 so that a gap similar to the thickness of each shoulder belt 4 is secured between the operation portion 14 and the back of the user 100. Thus, even if the buckles 6 and 7 are pushed by, for example, a collision of any thing with the back of the user 100, the joining of the buckles 6 and 7 is never released.

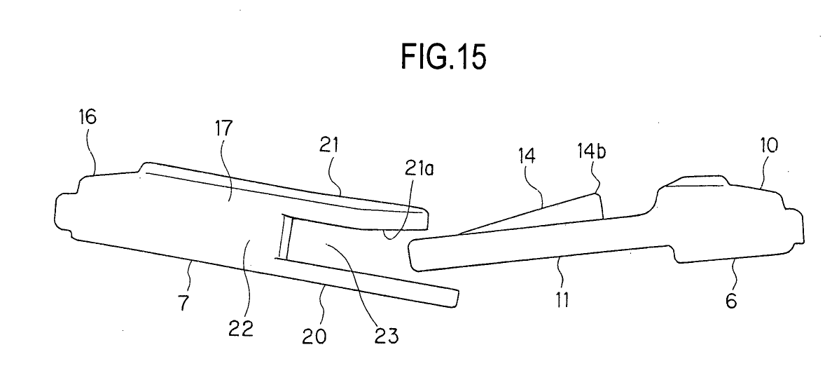

As evident from FIG. 10, with the hooking portion 14b fitted to the through hole 24, the hooking portion 14b is retracted to the side of the concave portion 23 with respect to the surface of the wall portion 21. As a result, even if the buckles 6 and 7 are pushed until they make contact with the back of the user, the wall portion 21 serves as a guard for the operation portion 14 and the probability that the operation portion 14 may be pushed in unexpectedly is eliminated securely. Of the wall portions 20 and 21 of the female buckle 7, as shown in FIG. 15, the wall portion 20 disposed on the outer side of the shoulder belt 4 is projected in the direction of the opening of the concave portion 23 more than the wall portion 21 disposed on the inner side of the shoulder belt 4. The wall portion 21 on the inner side has a tapered face 21a which increases an interval between the paired wall portions 20 and 21 as it goes more in the direction of the opening of the concave portion 23. Providing the female buckle 7 with such a configuration makes it easy to insert the tang 11 of the male buckle 6 into a socket 17 in the female buckle 7. That is, because the wall portion 20 is longer, the tang 11 of the male buckle 6 can be struck against the wall portion 20 with approaching it to the female buckle 7 from obliquely inside and the tang 11 can be fed along the wall portion 20 as a guide. Further, because the tapered face 21a is provided, the opening of the concave portion 23 is expanded thereby facilitating the insertion of the tang 11 into the socket 17.

As shown in FIGS. 1-3, an adjust belt 30 which connects the front side 4a of the shoulder belt 4 to the rear side 4b is provided on the bottom of each of the shoulder belts 4 of the infant carrier main body 2. One end of each adjust belt 30 is sewed to the bottom end portion (not seen in FIGS. 1 and 2 because it is hidden by the vertical holding seat 3) of the front side 4a of the shoulder belt 4 and the other end is connected to the bottom end portion 4c on the rear side 4b of the shoulder belt 4 through a ladder 31. By adjusting the length of the adjust belt 30 from the bottom end portion 4c on the front side of the shoulder belt 4 to the ladder 31, the length of the shoulder belt 4 can be changed corresponding to the physical feature of the user.

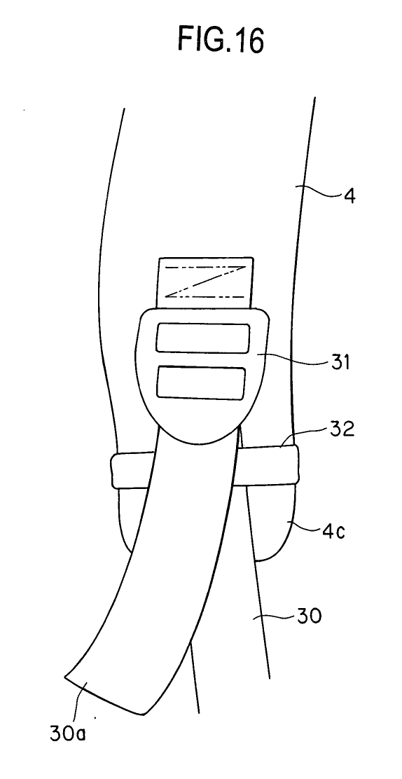

As shown in FIG. 16, a turning-up preventing belt 32 is attached below the attachment position of the ladder 31 on the rear side 4b of the shoulder belt 4. By passing the adjust belt 30 under the turning-up preventing belt 32 before passing through the ladder 31, the adjust belt 30 and the bottom end portion 4c on the rear side 4b of the shoulder belt 4 are bound together to prevent the bottom end portion 4c from being turned up. In the meantime, an excess portion 30a of the adjust belt 30 pulled out of the ladder 31 may be passed through that turning-up preventing belt 32.

Next, the vertical holding seat 3 will be described. As shown in FIGS. 1-3, the vertical holding seat 3 comprises a bottom portion 40 for supporting the hip of the infant, a seat main body portion 41 for supporting the back or chest of the infant, continued from the bottom portion 40 and a head protective portion 42 continued from the top end of the seat main body 41. The bottom portion 40 is connected to the bottom ends of the front sides 4a of the shoulder belts 4. Leg free portions 43 through which the infant legs pass are formed on both sides of the bottom portion 40. A deformable portion 41a which is composed of mesh material and foldable is provided on the seat main body portion 41 and the folding amount of that deformable portion 41a can be adjusted by adjusting the length of the adjust belt 41b passed through a belt passage 41c so as to change the width of the seat main body portion 41 corresponding to the physical feature of the infant. Additionally, a bridge belt 41d is provided below the adjust belt 41b and by joining its hooks 41e and 41f together, the width of the seat main body portion 41 at the crotch portion of the infant can be changed.

Hold portions 44 are provided on both sides of the seat main body portion 41. The width (length in the vertical direction) of the hold portion 44 is set to such an extent which allows itself to cover from the side or armpit of the infant to the thigh. Each hold portions 44 is connected detachably to the front side 4a of each shoulder belt 4 through each side buckle device 45. The head protective portion 42 is connected to the shoulder belts 4 through a head support 46 and rotary buckle devices 47.

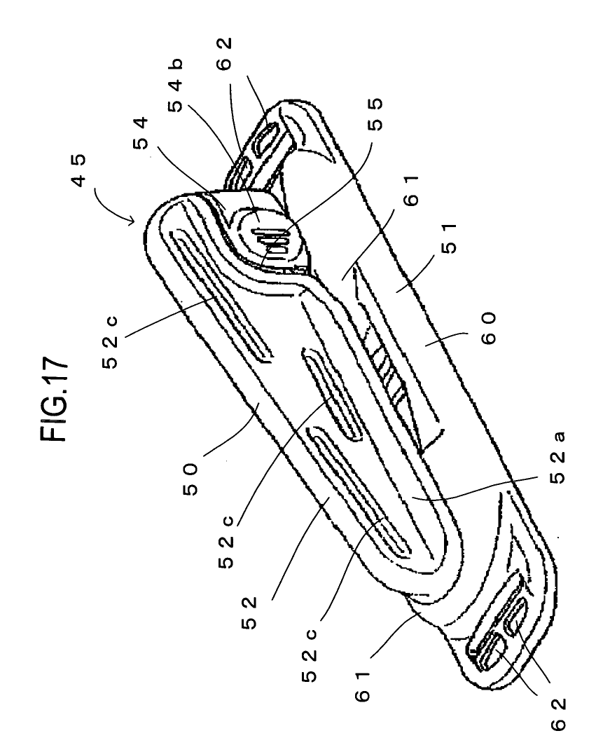

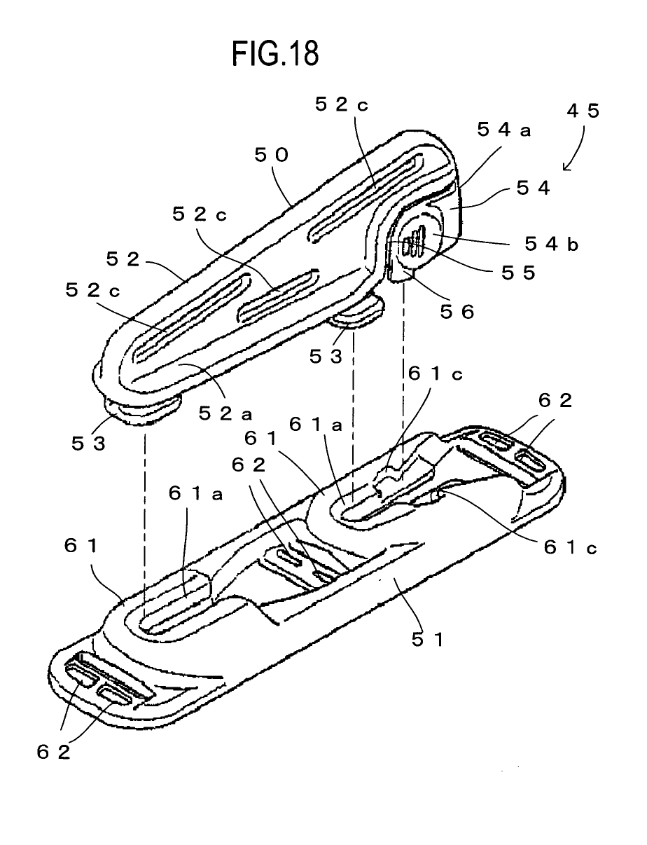

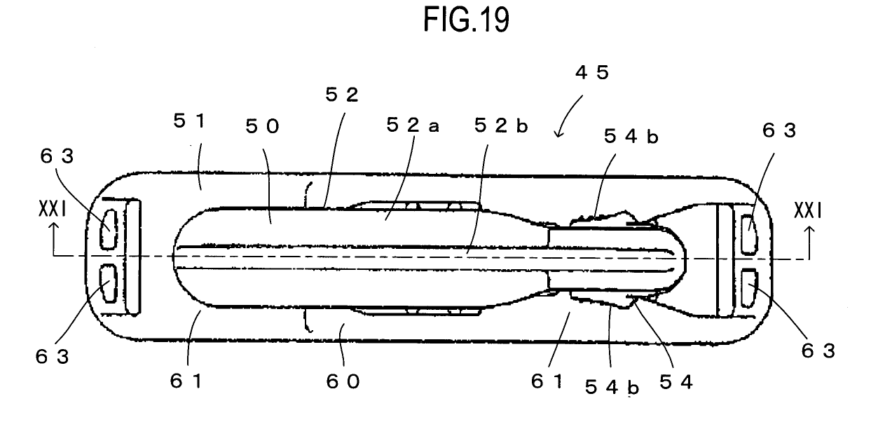

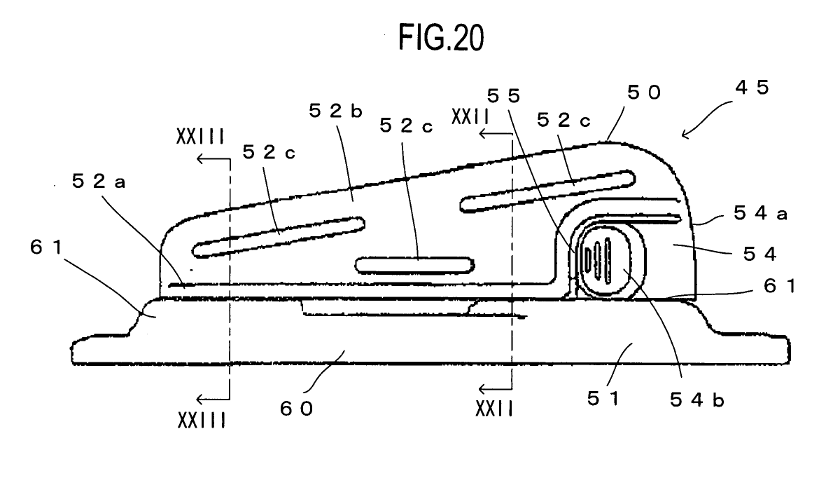

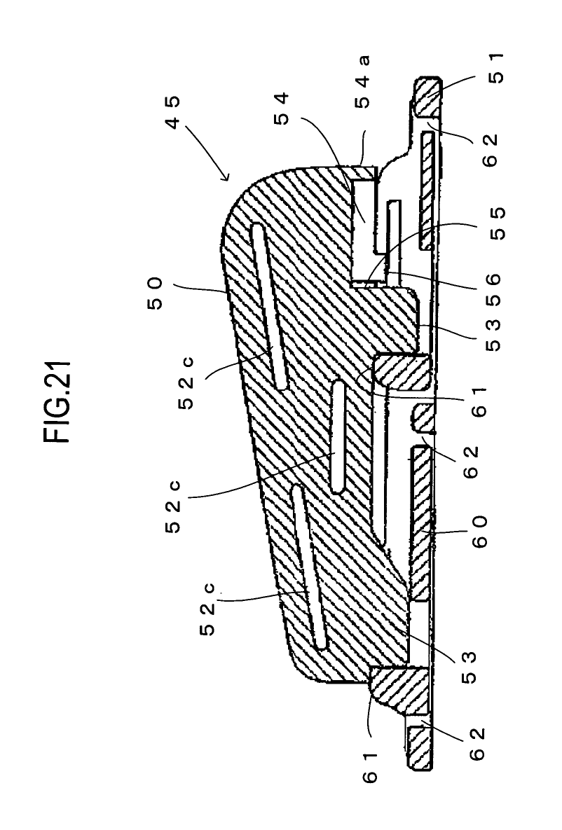

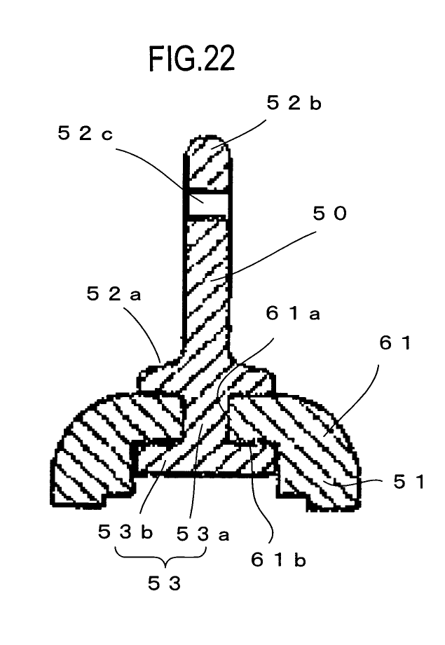

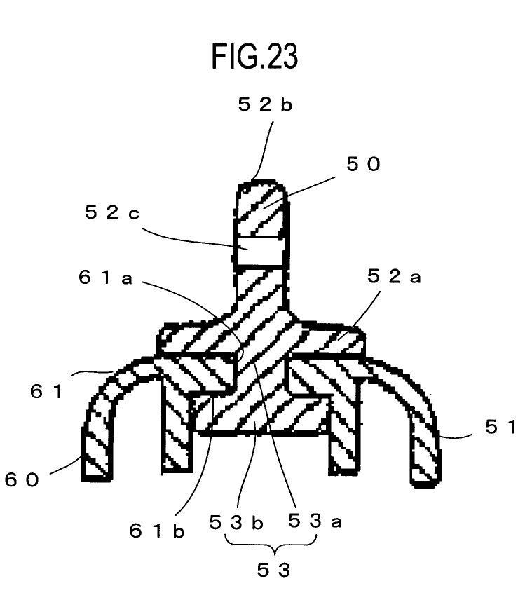

Hereinafter, the side buckle device 45 will be described. FIG. 17 is a perspective view of the joining condition of the side buckle device 45, FIG. 18 is a perspective view of joining release condition of the side buckle device 45, FIG. 19 is a plan view of the side buckle device 45, and FIG. 20 is a front view of the side buckle device 45. Further, FIG. 21 is a sectional view taken along the line XXI-XXI of FIG. 19, FIG. 22 is a sectional view taken along the line XXII-XXII of FIG. 20, and FIG. 23 is a sectional view taken along the line XXIII-XXIII of FIG. 20. As shown in these Figures, the side buckle device 45 comprises the male buckle 50 as a seat side engaging device and a female buckle 51 as a main body side engaging device. As evident in FIG. 18 and FIGS. 21-23, the male buckle 50 includes a buckle main body (engaging device main body) 52 and a pair of hooking portions 53. The buckle main body 52 and the hooking portion 53s are formed integrally of resin with each other.

The buckle main body 52 comprises a base 52a which is long in one direction and a flat handle 52b which is provided integrally with the base 52a such that it intersects at right angle on the front face of the base 52a. A grip portion 54 is provided at one end of the base 52a as unlocking means. The grip portion 54 is formed in a U-shape which opens toward the center in the length direction of the base 52a and connected to a handle 52b through a connecting portion 54a which is the proximal portion of that U-shape. The surrounding portion of the grip portion 54 except the connecting portion 54a is separated from the base 52a and the handle 52b by a slit 55. Operation portions 54b for unlocking operation are provided on both ends of the grip portion 54. A lock 56 is formed integrally below each operation portion 54b and the front end of each lock 56 is projected from the rear face of the base 52a. The lock 56 is also separated from the base 52a and the handle 52b by the slit 55. Thus, when the right and left operation portions 54b are gripped, the locks 56 are deflected such that they approach each other in the width direction (vertical direction in FIG. 19) of the buckle main body 52. In the handle 52b of the buckle main body 52, an appropriate number (2 in the Figure) of slots 52c for attaching the male buckle 50 to the front end of the hold portion 44 of the vertical holding seat 3 are formed. On the other hand, the hooking portion 53 is formed apart from the lock in the length direction of the base 52a. Each hooking portion 53 is formed in the shape of inverted T having a flat connecting portion 53a projected from the rear face of the base 52a and a flange 53b continued from the front end of the connecting portion 53a.

As shown in FIG. 18 in detail, the female buckle 51 has a base 60 which is long in one direction and a pair of receiving portions 61 provided on the base 60. Each receiving portion 61 is a portion which engages each hooking portion 53 of the male buckle 50 and comprises a slit 61a for allowing the connecting portion 53a of the hooking portion 53 to pass and a concave portion 61b for accommodating the flange 53b of the hooking portion 53. The concave portion 61b opens to one end side (the deep side in FIG. 18) in the length direction of the base 60 and the slit 61a is extended up to an opening end of the concave portion 61b. In the receiving portion 61 on one end side of the base 60, a lock receiving groove 61c is provided in each of paired inside walls of the slit 61a. Mounting holes 62 for mounting the base 60 to the shoulder belts 4 are provided on both ends in the length direction and the intermediate portion of the base 60.

In the above-mentioned side buckle device 45, by inserting the flanges 53b of the hooking portions 53 of the male buckle 50 into the concave portions 61b of the receiving portions 61 of the female buckle 51 so that the connecting portions 53a through the slits 61a, the hooking portions 53 are engaged with the receiving portions 61 so as to connect both the buckles 50 and 51. When the lock 56 of the male buckle 50 is engaged with the lock receiving groove 61c of the receiving portion 61 in this engagement condition, releasing of the hooking portions 53 from the receiving portions 61 is disabled so that the male buckle 50 is captured by the female buckle 51 in a joining condition. To release the male buckle 50 from the female buckle 51, the operation portions 54b of the grip portion 54 are gripped to deform the locks 56 elastically and then remove them from the lock receiving grooves 61c. With this condition, the male buckle 50 is slid in the opening direction of the concave portions 61b of the receiving portions 61.

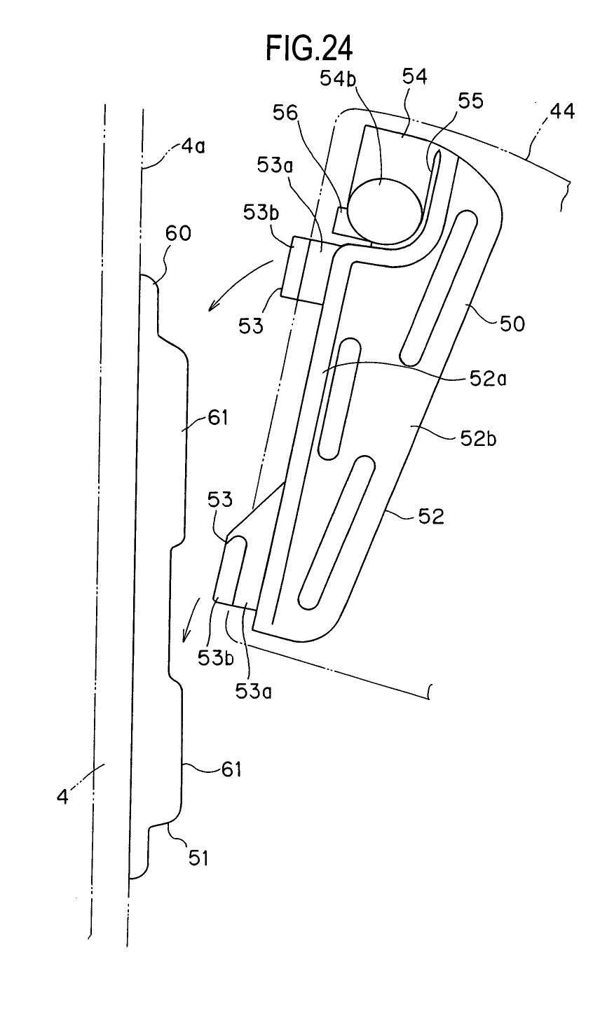

As shown in FIGS. 2 and 24, the female buckle 51 is attached to the front side 4a of each shoulder belt 4 in conditions in which the opening direction of each receiving portion 61 is directed upward. On the other hand, the male buckle 50 is attached to the front end of each hold portion 44 of the vertical holding seat 3 with the grip portion 54 being directed upward. Although FIGS. 2 and 24 show only the mounting condition of the buckles 50 and 51 onto one side holding portion 44 and one side shoulder belt 4, the opposite side is the same. If the buckles 50 and 51 are mounted as described above, it comes that the hooking portions 53 and the receiving portions 61 are arranged with an appropriate interval in the vertical direction. Then, each of the hooking portions 53 of the male buckle 50 of the holding portion 44 is engaged with each of the receiving portions 61 of the female buckle 51 of the shoulder belt 4 from obliquely upward as indicated with an arrow in FIG. 24, so that the holding portion 44 can be joined to the shoulder belt 4.

In the above-described joining condition, since the hooking portions 53 pairing up and down engage each receiving portion 61, even if any one of the hooking portions 53 or the receiving portions 61 is damaged, joining between the holding portion 44 and the shoulder belt 4 is maintained by remaining hooking portion 53 and receiving portion 61. Therefore, the safety is kept high. In order to prevent occurrence of such an error as engaging of the upper hooking portion 53 with the lower receiving portion 61, the thickness and width of the flange 53b of the hooking portion 53 are made different between the upper and lower hooking portions 53.

Further, because the plural hooking portions 53 and receiving portions 61 can be engaged with each other only by sliding the male buckle 50 along the female buckle 51, it takes less labor and time as compared with a case where the hooking portion 53 and the receiving portion 61 are engaged with each other individually. Further, because to release the holding portion 44 from the shoulder belt 4, nothing but gripping the grip portions 54 is needed, it takes less labor and time. However, until the pairing operation portions 54b are pushed at the same time, the capturing of the male buckle 50 by the female buckle 51 is not released and therefore, there is no possibility that the capturing may be released unexpectedly. Further, because only by releasing the buckles 50 and 51, the side portion of the vertical holding seat 3 is opened completely as evident from FIG. 2, an infant can be loaded or unloaded easily. Further, because the male buckle 50 and the female buckle 51 are straightened over substantially entire length of the width in the vertical direction of the holding portion 44, if the buckles 50 and 51 are connected, it comes that the holding portion 44 is connected to the shoulder belt 4 over substantially entire width so that there is no gap on the side of the infant and consequently the safety is intensified further. In the mean time, although even when the upper and lower hooking portions 53 are formed continuous integrally, the holding portion 44 can be connected to the shoulder belt 4 over substantially entire width. However, in this case, it is necessary to bring the bottom end of the holding portion 44 up to the top end of the female buckle 51 and connect the buckles 50 and 51. Contrary to this if the hooking portions 53 and the receiving portions 61 are separated vertically as evident from FIG. 24, it is only necessary to bring the holding portion 44 up to a state in which each hooking portion 53 is located just above each receiving portion 61 and therefore, burden on operation of the holding portion 44 may be small.

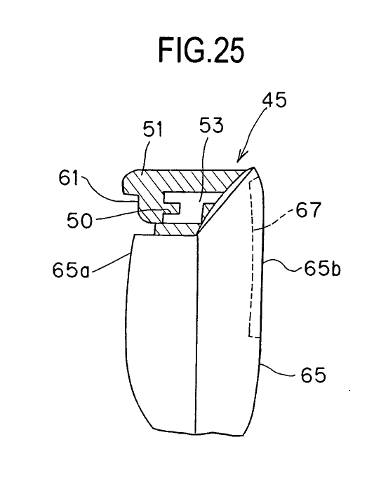

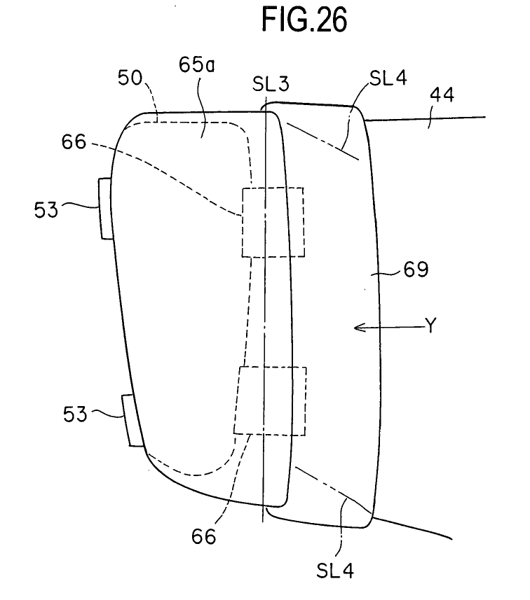

As shown in FIG. 25, a buckle cover 65 comprising an external cover portion 65a disposed on the external face side of the vertical holding seat 3 and an internal cover portion 65b disposed on the internal face side of the vertical holding seat 3 is provided at the front end of each holding portion 44. The male buckle 50 is disposed so that it is buried in the buckle cover 65. As shown in FIG. 26, buckle fixing belts 66 are passed through slots 52c (see FIG. 18) in the male buckle 50 and those buckle fixing belts 66 are sewed together with the external cover portion 65a and the internal cover portion 65b on the sewing line SL3. Consequently, the male buckle 50 is fixed on the holding portion 44.

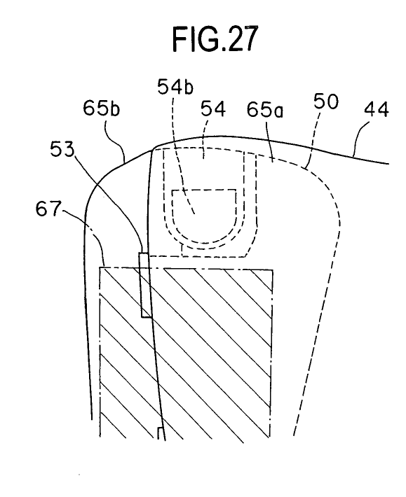

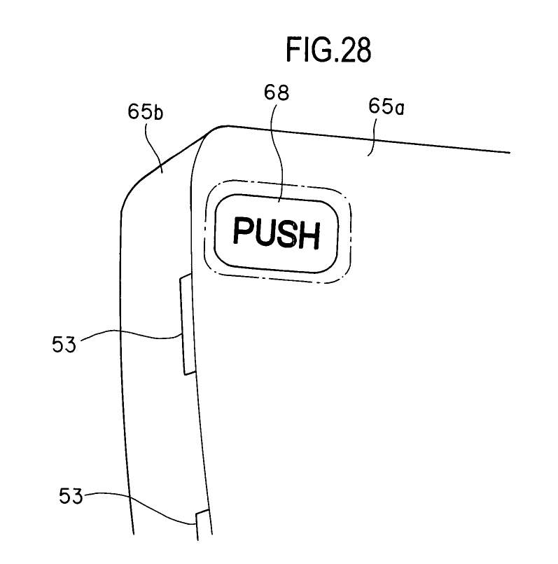

As evident from FIG. 25, the internal cover portion 65b of the buckle cover 65 is provided to extend to the front end side of the holding portion 44 more than the external cover portion 65 and the lengths of the buckles 50 and 51 are set to such an extent that they cover the female buckle 51 substantially completely when the buckles 50 and 51 are connected to each other. By providing with the internal cover portion 65b in this way, the infant accommodated in the vertical holding seat 3 can be protected from making contact with the buckles 50 and 51. As shown in FIGS. 25 and 27, the internal cover portion 65b incorporates a flat core material 67 for preventing peeling. As the core material 67, for example, densely knitted belt member, resin member or the like may be used. As evident from FIG. 27, no core material 67 is provided at a portion opposing the operation portion 54b of the internal cover portion 65b so that the operation portion 54b of the male buckle 50 can be pushed from outside the buckle cover 65. Further, the external cover portion 65a includes no such core material 67. Consequently, a portion opposing each of the operation portions 54b of the buckle cover 65 is constructed as a low stiffness portion. As shown in FIG. 28, an identification mark 68 is provided on the surface of the buckle cover 65 such that it matches the operation portion 54b in terms of position. When the user grips the portion of this identification mark 68, the operation portions 54b can be pushed from outside the buckle cover 65 securely.

As shown in FIG. 26, a belt-like grip 69 is provided on the surface of the external cover 65a of the buckle cover 65 so that it traverses the holding portion 44 in the vertical direction. The grip 69 is sewed to the buckle cover 65 integrally along the sewing lines SL4 at its upper and bottom ends. The grip 69 is provided for the user to hold each holding portion 44 when joining the buckles 50 and 51 or releasing the joining condition. The grip 69 is preferred to have a core material. The user can bring up the holding portion 44 by inserting his or her fingers in between the grip 69 and the buckle cover 65 from the proximal end side of the holding portion 44 toward the front end side as indicated with an arrow Y in FIG. 26 so as to connect the male buckle 50 to the female buckle 51. Each sewing line SL4 is set so that it extends obliquely upward toward the front end of the holding portion 44 for the user to be capable of inserting his or her fingers easily. Further, it is preferable that the supporting position of the grip 69 and the hooking portions 53 of the male buckle 50 are as near each other as possible and thus, the grip 69 is preferred to be located at a position as near the sewing line SL3 as possible.

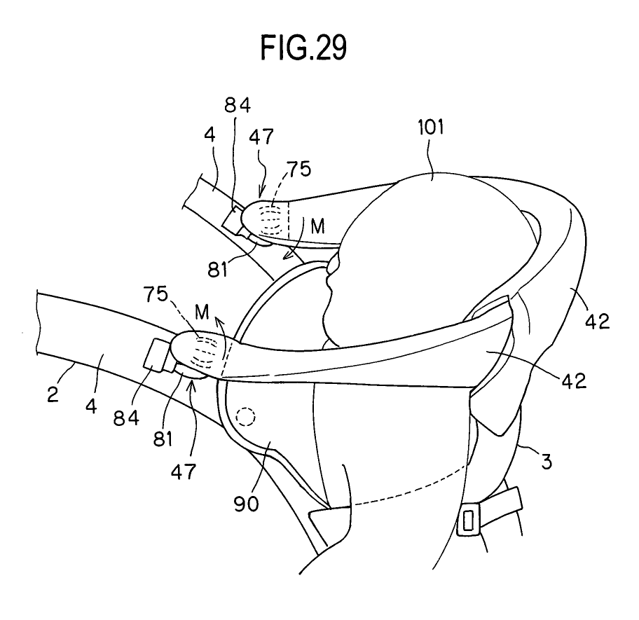

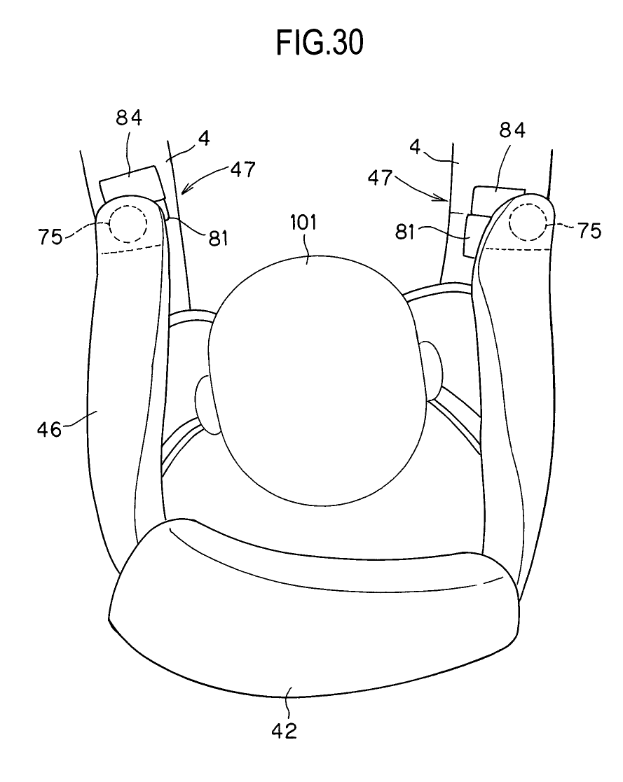

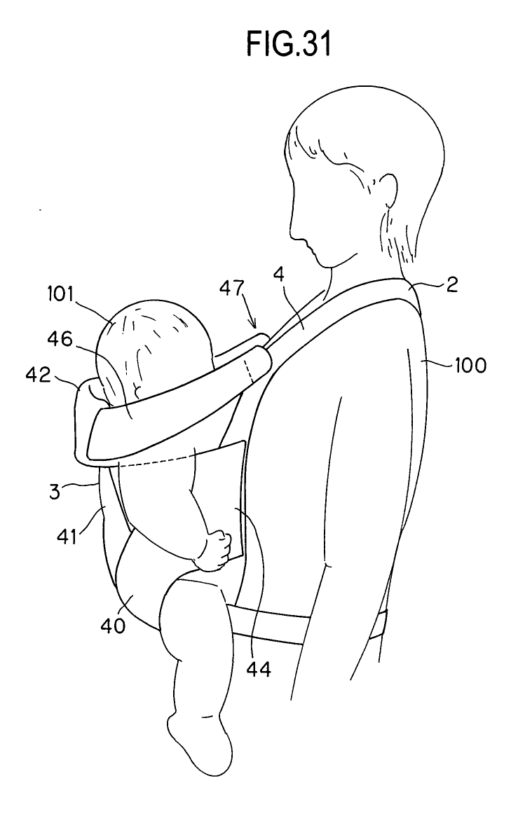

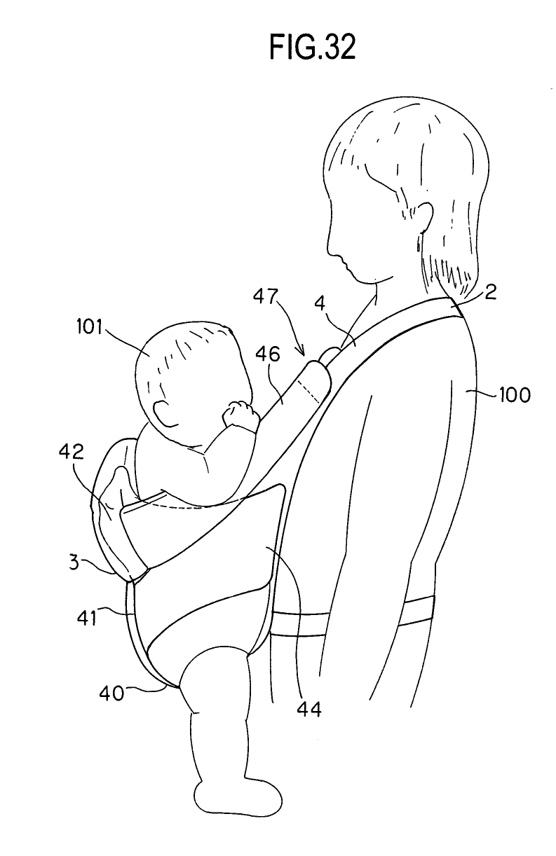

Next, the head support 46 and the rotary buckle device 47 for mounting it will be described. FIG. 29 shows the use condition of the head support 46. The head protective portion 42 of the vertical holding seat 3 is provided so as to support the head portion of an infant 101 carried by the vertical holding seat 3 and at the same time constructed in the form of a bag whose both sides are open. The head support 46 is passed through the inside of the head protective portion 42 and so as to be place over the side of the infant 101 while both ends thereof are connected to the shoulder belts 4 through the rotary buckle devices 47. As shown in FIGS. 31 and 32, the head protective portion 42 can be folded back by two stages outward and downward of the vertical holding seat 3. With the head protective portion 42 folded back shallowly as shown in FIG. 31, the head support 46 is connected to the shoulder belts 4 through the shoulders of the infant 101. On the other hand, when the head protective portion 42 is folded back deeply as shown in FIG. 32, the head support 46 is connected to the shoulder belts 4 through the sides of the infant 101.

When the head protective portion 42 is folded back as described above, the portions straightened out of the head protective portion 42 of the head support 46 are twisted so that they enter into the inside of the vertical holding seat 3. If this phenomenon is left as it is, space around the head portion of the infant 101 is narrowed. The head support 46 and each of the rotary buckle devices 47 of this embodiment have a feature for suppressing the deflection of the head support 46. Hereinafter, the head support 46 and the rotary buckle device 47 will be described.

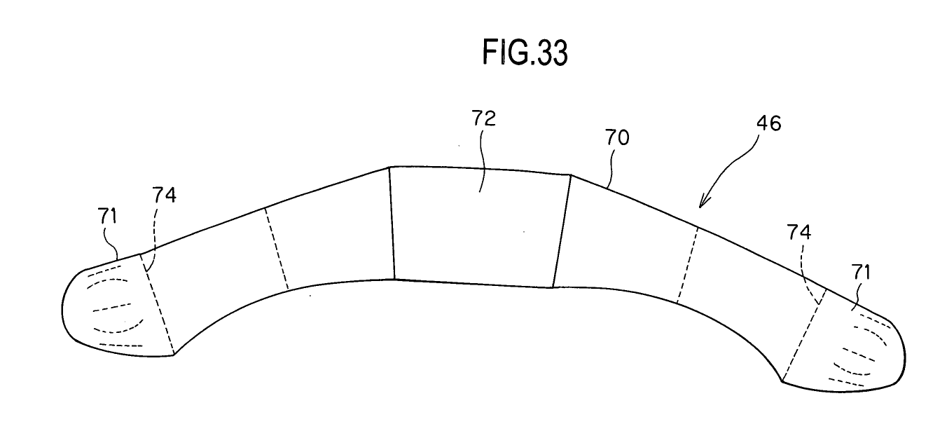

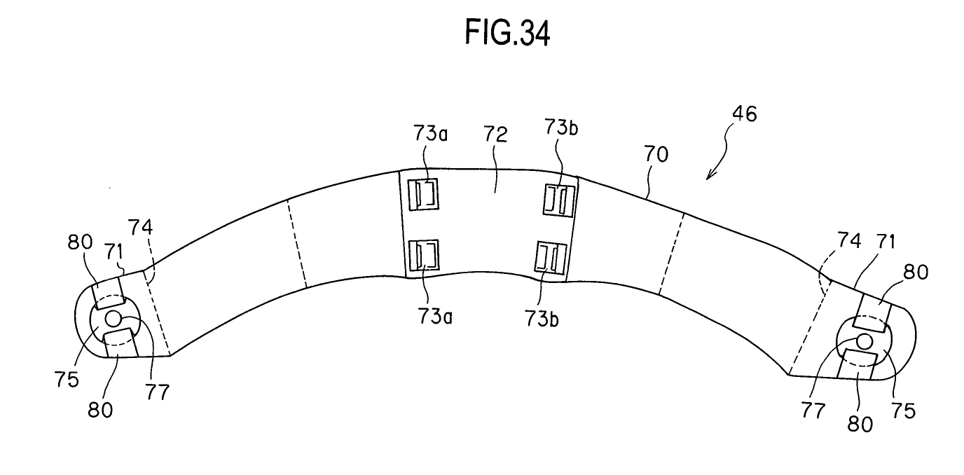

FIG. 33 is a front view of the head support 46, and FIG. 34 is a rear view thereof. As shown in these Figures, the head support 46 has a supporting portion 70 curved in an arch shape and a pair of connecting portions 71 disposed on both ends of the supporting portion 70. A deformable portion 72 is provided in the center of the supporting portion 70 and two pairs of hooks 73a and 73b are provided on both sides of the deformable portion 72. The deformable portion 72 is provided so as to be foldable by omitting such an internal mounting material as a pad contained in the head support 46. The length of the head support 46 can be adjusted by folding the deformable portion 72 so that the hooks 73a and 73b engage each other. Consequently, the deformable portion 72 and the hooks 73a and 73b function as length adjusting means. These deformable portion 72 and hooks 73a and 73b are disposed at portions hidden by the head protective portion 42 of the head support 46. Therefore, these parts are not exposed in the head space for the infant so that comfort for the infant is maintained. In the meantime, the hooks 73a and 73b may be in a pair. The length adjusting means can be modified in various ways, for example, by providing both ends of the deformable portion 72 with a belt and ladder, the folding length of the deformable portion 72 can be adjusted without steps.

The connecting portions 71 are extended from both ends of the supporting portion 70 such that they are bent to the outer peripheral side relative to the curve direction of the supporting portion 70. Bending lines 74 are formed on the boundaries between the supporting portion 70 and the connecting portions 71 by sewing cloth of the head support 46. Each bending line 74 is provided to have a habit of being bent between the supporting portion 70 and the connecting portion 71. The sewing for forming the bending line 74 may be implemented on only one side of the head support 46 or so that it penetrates through in the thickness direction of the head support 46. The head support 46 is mounted on the head protective portion 42 in such a direction that its outer peripheral side is directed upward with respect to the curve direction of the supporting portion 70. That is, the head support 46 is mounted on the head protective portion 42 in such a direction that the supporting portion 70 is extended curved in the arch shape downward from the head protective portion 42.

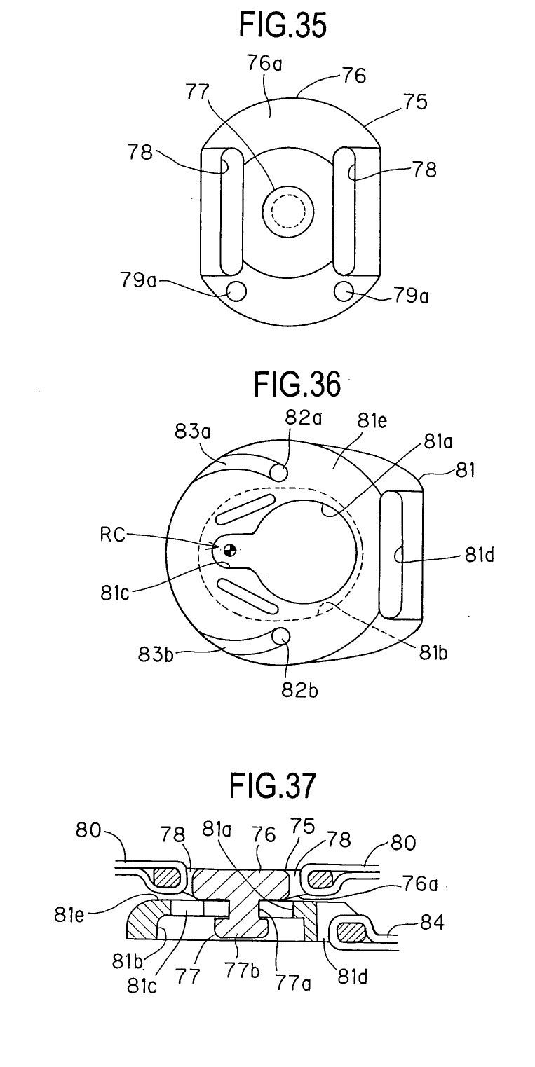

The male buckle 75 of the rotary buckle device 47 is mounted on each connecting portion 71. As shown in FIGS. 35 and 37, the male buckle 75 has a circular base 76 and a hooking portion 77 projected from the center position of the base 76. The hooking portion 77 comprises a supporting shaft 77a coaxial with the base 76 and a flange 77b which is disposed at the front end of the supporting shaft 77a. The base 76 has a pair of belt passage holes 78 which sandwich the hooking portion 77. The surface 76a of the base 76 is provided with a spherical swelling whose vertex is on the hooking portion 77. The surface 76a is provided with a pair of convex portions 79a and 79b as locking means. These convex portions 79a and 79b are provided at an equal distance from the hooking portion 77. The male buckle 75 is fixed on the connecting portion 71 by sewing buckle fixing belts 80 passed through the belt passage holes 78 onto the connecting portion 71 of the head support 46 (see FIG. 34). In the meantime, the male buckle 75 is mounted on the external face side of the head support 46, that is, on a face opposite to a side opposing the infant.

FIG. 36 shows the female buckle 81 of the rotary buckle device 47. As shown in FIG. 37, the female buckle 81 comprises a passage hole 81a which allows the hooking portion 77 of the male buckle 75 to pass through, a concave portion 81b which engages the flange 77b of the hooking portion 77 and a slit 81c which allows a shaft portion 77a of the hooking portion 77 to pass through. By inserting the shaft portion 77a of the hooking portion 77 inserted into the passage hole 81a into the slit 81c so as to engage the concave portion 81b with the flange 77b, the male buckle 75 and the female buckle 81 are connected so that they are capable of rotating relatively around the shaft portion 77a of the hooking portion 77.

The belt passage hole 81d is provided in the female buckle 81. The belt passage hole 81d is provided on an opposite side to the slit 81c across the passage hole 81a. A pair of concave portions 82a and 82b as locking means and guide grooves 83a and 83b which communicate with the concave portions 82a and 82b are provided in the surface of the female buckle 81 (face opposing the male buckle 75). The concave portions 82a and 82b are provided at an equal distance to the rotation center RC in the slit 81c (which coincides with the center of the shaft of the hooking portion 77 inserted therein). The guide grooves 83a and 83b are curved around the rotation center RC. The female buckle 81 is fixed to the shoulder belt 4 such that it is hung from the buckle fixing belt 84 by sewing the buckle fixing belt 84 passed through the belt passage hole 81d onto the shoulder belt 4 (see FIG. 2).

With the above-described structure, if the male buckle 75 is pulled up by inserting the hooking portion 77 of the male buckle 75 fixed on the head support 46 into the passage hole 81a in the female buckle 81 on the side of the shoulder belt 4, the shaft portion 77a of the hooking portion 77 enters into the slit 81c so that the buckles 75 and 81 are engaged with each other. Consequently, the head support 46 is connected to the shoulder belt 4. Because the male buckle 75 can rotate with respect to the female buckle 81 when they are connected, even if the head protective portion 42 of the vertical holding seat 3 is folded back downward, it is not necessary to reattach the head support 46 to the shoulder belt 4 by turning back both ends thereof. Further, with the head protective portion 42 extended, the head support 42 is straightened outward due to the curve provided on the supporting portion 70 of the head support 46, so that space around the head portion of the infant is expanded thereby improving comfort for the infant.

Although when the head support 46 is twisted inward by folding back the head protective portion 42 downward, the male buckle 75 rotates inward as indicated with an arrow M in FIG. 29 in connection with this, because the connecting portions 71 are bent to the outer peripheral side in the curve direction with respect to the supporting portion 70, the degree of the twisting of the supporting portion 70 inward with respect to the rotation of each connecting portion 71 is smaller as compared with a case where the head support 46 is entirely curved into the arch shape. Further, because each supporting portion 70 is bent along the bending line 74 with respect to the connecting portion 71, the twisting of the supporting portion 70 inward is reduced further thereby suppressing a deflection of the head support 46 inward. Further, because each male buckle 75 is fixed to the connecting portion 71 on both sides thereof across the rotation center, the connecting portion 71 is deflected inward with respect to the male buckle 75 when the head protective portion 42 is pushed back, so that there is no possibility that the supporting portion 70 may enter into the inside of the vertical holding seat 3.

Both when the head protective portion 42 is extended and the head protective portion 42 is folded back, the convex portions 79a and 79b of the buckle 75 engage the concave portions 82a and 82b appropriately. More specifically, when the head protective portion 42 is straightened, the convex portion 79a of the male buckle 75 on the right shoulder side engage the concave portion 82a of the female buckle 81 and the convex portion 79b of the male buckle 75 on the left shoulder side engage the concave portion 82b of the female buckle 81. On the other hand, when the head protective portion 42 is folded back, the convex portion 79b of the male buckle 75 on the right shoulder side engages the concave portion 82b of the female buckle 81 and the convex portion 79a of the male buckle 75 on the left shoulder side engages the concave portion 82a in the female buckle 81. Due to these engagements, the male buckle 75 is captured under an appropriate force at a position suitable for the conditions in which the head protective portion 42 is straightened and the head protective portion 42 is folded back, thereby suppressing a play in the circumferential direction of the male buckle 75 and consequently, the posture of the head support 46 can be stabilized. In the meantime, it is permissible that the head support 46 cannot be detached from the head protective portion 42.

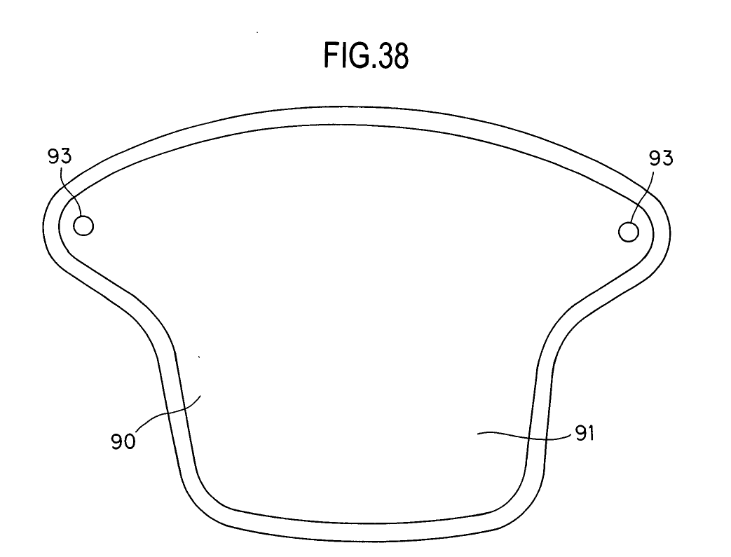

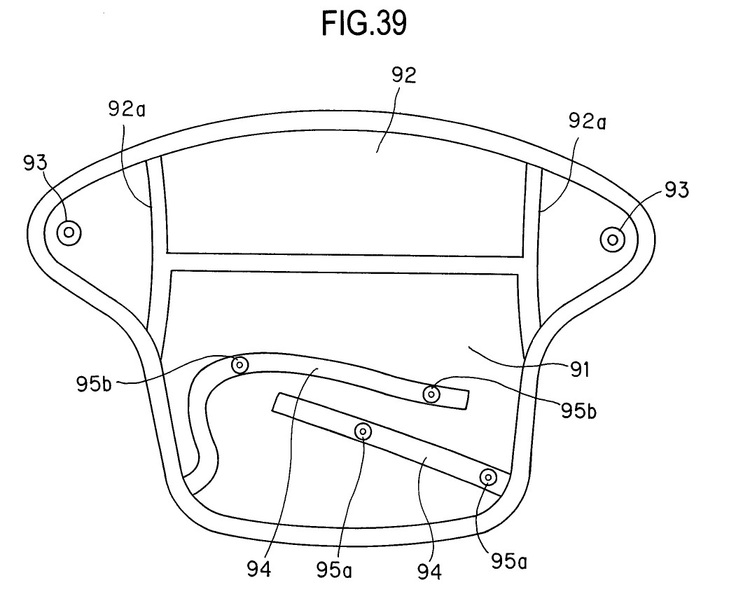

As shown in FIG. 29, the infant carrier 1 is provided with a bib 90. The bib 90 is so constructed to be usable both when an infant is carried in his or her backward facing direction such that the user faces the infant face to face and when the infant is carried in his or her forward facing direction. FIG. 38 is a front view of the bib 90 and FIG. 39 is a rear view thereof. As shown in these Figures, the bib 90 comprises a bib main body 91 for receiving saliva from the infant's mouth, a pocket 92 provided on the rear side of the bib main body 91, push-type hooks 93 as an upper clamp disposed on both sides of that pocket 92 and a pair of clamp strings 94 as a lower clamp provided on the lower side edge of the bib main body 91.

The pocket 92 is constructed in the shape of a bag and can be attached to the vertical holding seat 3 so as to cover the head protective portion 42. Opening portions 92a which allow the head support 46 to pass through are provided on both sides of the pocket 92. An appropriate number of hooks 95a and 95b (two in this Figure) are provided on the clamp strings 94 in order to connect or disconnect these.

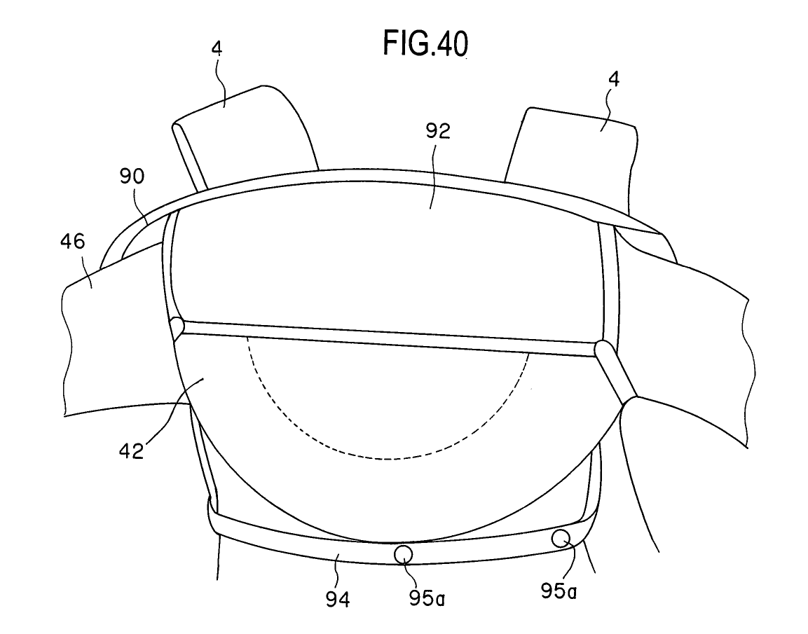

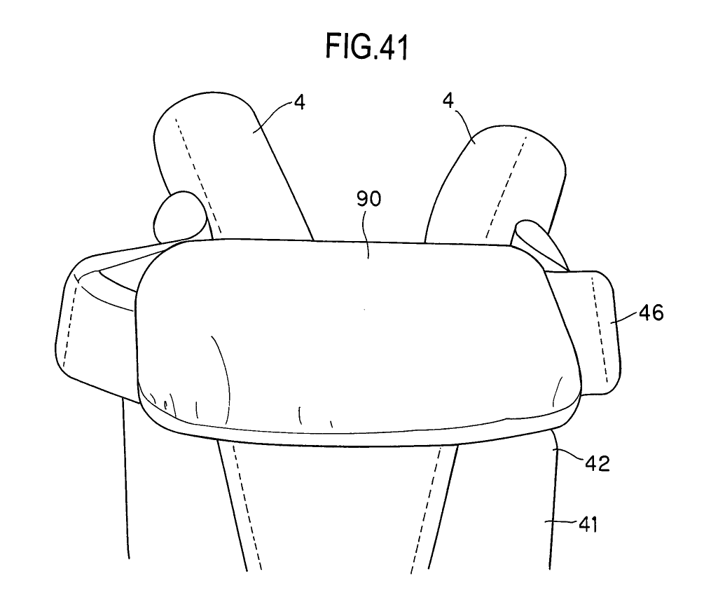

When the infant is carried in the forward facing direction, as shown in FIG. 40, the head protective portion 42 is covered with the pocket 92 by hanging the bib main body 91 on the inner side of the head protective portion 42. Further, the clamp strings 94 are placed on the seat main body 41 of the vertical holding seat 3 and connected to each other by means of the hooks 95a and 95b. If the head protective portion 42 is folded back downward as indicated in FIG. 41 from this condition, the folded portion is covered with the bib main body 91. Consequently, when the infant is carried in the forward facing direction, the folded portion of the head protective portion 42 likely to be contaminated can be covered by the bib. On the other hand, because portions of the shoulder belts 4 near the chest are likely to be contaminated when the infant is carried in the backward facing direction, as shown in FIG. 29, the bib main body 91 is disposed near the chest on the front sides 4a of the shoulder belts 4 and clamped with the hook 4d (only one side shown in FIG. 2) provided on each shoulder belt 4 and the hook 93 on the upper portion of the bib 90. Further, the clamp strings 94 are placed on the inner sides of both the shoulder belts 4 and the hooks 95a and 95b are clamped together. Because in any case of the carrying in the forward facing direction and carrying in the backward facing direction, the top portion of the bib 90 is fixed by the pocket 92 or the hooks 93 and the bottom portion is also fixed by the clamp strings 94 and therefore, there is no possibility that the bib 90 may be deflected or peeled upward. In the meantime, the bib 90 may be attached either before or after carrying the infant. The hook 4d of each shoulder belt 4 may be provided on the internal face side of the shoulder belt 4. If the infant carrier 1 is so constructed to be capable of carrying an infant on the back of user, it is permissible to attach the hooks 4d to the back sides 4b of the shoulder belts 4 to make the bib 90 available when the infant is carried on the back of user.

The present invention is not restricted to the above-described embodiments but may be embodied in various forms. For example, the vertical holding seat 3 is not limited to the type completely separable from the infant carrier 1 but only part thereof may be detachable from the infant carrier main body 2 in order to bring up or down the infant. The connecting device for connecting the back sides 4b of the shoulder belts 4 is not restricted to the rotary buckle device 5 but it is permissible to use other hook types. The clamp for connecting the holding portion 44 of the vertical holding seat 3 to the shoulder belt 4 is not restricted to the type in which the receiving portions 61 of the female buckle 51 of the side buckle device 45 is provided on the common base 60 but the base may be different for each receiving portion 61. As long as the hooking portions 53 of the male buckle 50 are provided on a single unit buckle main body 52, joining and releasing of the joining of those hooking portions 53 can be achieved simultaneously. If the receiving portions 61 are separated, it is permissible to provide the lock receiving groove 61c in any of the receiving portions 61 or it may be provided in other member other than those receiving portions. The configuration of each hooking portion 53 is not restricted to the one shown in the Figure but it may be in the form of a hook. The clamp for connecting the head support 46 to the shoulder belts 4 is not restricted to the rotary buckle device 47 but it is permissible to use a hook-shaped one. The upper clamp and lower clamp of the bib 90 are not restricted to the hooks 93 and the clamp strings 94 but other various kinds of fixing means such as the buckle, belt may be used as long as it can fix the bib main body 90 to the infant carrier main body 2 or the vertical holding seat 3.

1. An infant carrier comprising:
an infant carrier main body having a pair of shoulder belts to be mounted around the shoulders of a user; and
a vertical holding seat to be mounted on the infant carrier main body so as to hold an infant in a vertical holding condition, wherein
the back sides of the pair of the shoulder belts are provided with curves in directions that they approach each other, and
joining means for joining together the shoulder belts is provided at the vertex positions of the curves.

2. The infant carrier according to claim 1, wherein the joining means is so constructed that the joining is released by pushing operation from an internal face side of the infant carrier main body to an external face side thereof.

3. The infant carrier according to claim 1, wherein the joining means includes a pair of joining devices mounted on each of the pair of the shoulder belts and capable of being joined and released, and the pair of the joining devices are capable of rotating relatively in the vertical direction in joining condition thereof.

4. The infant carrier according to claim 1, wherein the joining means includes a pair of joining devices mounted on each of the pair of the shoulder belts and capable of being joined and released, one of the pair of the joining devices is provided with an operation portion deformable elastically from the internal face side of the infant carrier main body to the external face side while the other joining device is provided with a pair of wall portions disposed on the internal face side and the external face side of the infant carrier main body such that they oppose each other so as to form a concave portion in which the operation portion is to be inserted, the wall portion on the internal face side of the pair of the wall portions is provided with a passage hole communicating with the concave portion and the operation portion is provided with a hooking portion capable of being hooked on an inside wall of the passage hole.

5. The infant carrier according to claim 4, wherein the hooking portion is capable of rotating along the inside wall of the passage hole.

6. The infant carrier according to claim 5, wherein the other joining device is provided with a stopper for limiting rotation range of the one joining device.

7. The infant carrier according to claim 4, wherein, of the pair of the wall portions, the wall portion on the external face side is projected in an opening direction of the concave portion with respect to the wall portion on the internal face side.

8. The infant carrier according to claim 4, wherein the wall portion on the internal face side is provided with a tapered face which increases an interval between the pair of the wall portions as it goes in an opening direction of the concave portion.

9. An infant carrier comprising an infant carrier main body to be mounted on a user and a vertical holding seat to be mounted on the infant carrier main body so as to hold an infant in a vertical holding condition, wherein
the vertical holding seat is provided with a pair of holding portions which are placed on the sides of the infant while the front ends thereof are joined to the infant carrier main body, the front end of each of the holding portions is provided with a seat side clamp having a single unit clamp main body and plural hooking portions formed integrally with the clamp main body in conditions in which they are departed from each other in the vertical direction and the infant carrier main body includes main body side clamps, each of which has the same number of receiving portions as that of the hooking portions, the receiving portions being capable of engaging each of the plural hooking portions of the seat side clamp.

10. The infant carrier according to claim 9, wherein the clamp main body of the seat side clamp comprises a lock which engages a lock receiver of each of the main body side clamps when each of the hooking portions engages the receiving portions so as to disable disengagement between the hooking portions and the receiving portions and lock releasing means for deforming the lock elastically in a direction that the lock is disengaged from the lock receiver by an unlocking operation to a predetermined operation portion.

11. The infant carrier according to claim 10, wherein, in each of the main body side clamps, each of the receiving portions is provided on a common base and the lock receiver is provided on the base.

12. The infant carrier according to claim 9, wherein the front end of each holding portion is provided with a cover for covering the seat side clamp.

13. The infant carrier according to claim 12, wherein the cover comprises an external cover portion for covering the seat clamp from an external face side of the vertical holding seat and an internal cover portion for covering the seat side clamp from an internal face side of the vertical holding seat while the internal cover portion is longer than the external cover portion.

14. The infant carrier according to claim 12, wherein an internal cover portion includes a core material for preventing the internal cover portion from being turned up.

15. The infant carrier according to claim 10, wherein a front end of each holding portion is provided with a cover for covering the seat side clamp and a portion of the cover opposing the operation portion has no core material so that the portion of the cover is formed as a low stiffness portion.

16. The infant carrier according to claim 15, wherein the cover is provided with an identification mark indicating a position of the operation portion.

17. The infant carrier according to claim 9, wherein an outer face side of the holding portion is provided with a grip for the user to hold the holding portion.

18. The infant carrier according to claim 17, wherein the grip is formed into a belt traversing the holding portion vertically and an upper end portion and a lower end portion of the grip are sewed to the holding portion while the sewing lines are extended obliquely upward toward the front end of the holding portion.

19. An infant carrier comprising:
an infant carrier main body to be mounted on a user;
a vertical holding seat capable of being attached to the infant carrier main body so as to hold an infant in a vertical holding condition, and having on a top end thereof a head protective portion for supporting a head portion of the infant so as to be foldable downward; and
a head support which is projected sideway from the head protective portion and both ends thereof are capable of being joined to the infant carrier main body, wherein
the head support includes a supporting portion extended from the head protective portion downward so as to be curved in an arch shape and connecting portions extended from both ends of the supporting portion so as to be bent to the outer peripheral side of the supporting portion, and on an external face side of each of the connecting portions of the head support and each of head support mounting positions of the infant carrier main body, there are provided clamps capable of being joined to and released from each other and rotating relatively when the clamps are joined together.

20. The infant carrier according to claim 19, wherein a bending line is provided on each boundary between the supporting portion of the head support and each of the connecting portions.

21. The infant carrier according to claim 20, wherein the bending line is formed by sewing together cloth of the head support in a thickness direction thereof.

22. The infant carrier according to claim 19, wherein each of the clamps provided on the connecting portions of the head support is fixed on each of the connecting portions on both sides thereof across a rotation center line of each clamp.

23. The infant carrier according to claim 19, wherein lock means is provided between each of the clamps provided on each of the connecting portions of the head support and each of the head support mounting positions of the infant carrier main body, and the lock means is capable of capturing the both clamps with respect to a rotation direction of the clamps at each of a position suitable for a condition in which the head protective portion is straightened upward and a position suitable for a condition in which the head protective portion is folded back downward.

24. The infant carrier according to claim 23, wherein as the locking means, convex and concave portions are provided in opposing faces of the clamps provided on each of the connecting portions of the head support and each of the head support mounting positions of the infant carrier main body.

25. The infant carrier according to claim 19, wherein the supporting portion of the head support is provided with length adjusting means.

26. The infant carrier according to claim 25, wherein, on the supporting portion, there are provided, as the length adjusting means, a deformable portion foldable in a length direction of the supporting portion and a pair of hooks disposed on both sides of the deformable portion and capable of being joined to and released from each other.

27. The infant carrier according to claim 25, wherein the head support is constructed as a separate member capable of being inserted into and removed from the head protective portion, and the length adjusting means is provided at a portion hidden by the head protective portion of the head support.

28. An infant carrier comprising:
an infant carrier main body to be mounted on a user;
a vertical holding seat capable of being attached to the infant carrier main body so as to hold an infant in a vertical holding condition, and having on a top end thereof a head protective portion for supporting a head portion of the infant so as to be foldable downward;
a head support which is projected sideway from the head protective portion and both ends thereof are capable of being joined to the infant carrier main body; and
a bib capable of being selectively mounted on the infant carrier main body or the head protective portion, wherein the bib includes a bib main body for receiving saliva of the infant; a pocket capable of being mounted on the vertical holding seat so as to cover the head protective portion and having opening portions allowing the head support to pass through on both sides thereof; upper clamps for attaching both ends of an upper portion of the bib main body to the infant carrier main body; and lower clamps for attaching a lower portion of the bib main body to the infant carrier main body or the vertical holding seat selectively.

29. The infant carrier according to claim 28, wherein, as the upper clamp, a pair of push type hooks are provided on both sides of the upper portion of the bib main body, and the infant carrier main body has hooks which clamp with the hooks on the bib side.

30. The infant carrier according to claim 29, wherein the infant carrier main body is provided with a pair of shoulder belts to be placed on the shoulders of the user and the hooks of the infant carrier main body are provided on the front sides of the shoulder belts, respectively.

31. The infant carrier according to claim 28, wherein a pair of clamp strings capable of being joined to or released from each other are provided as the lower clamps.

32. A bib for an infant carrier comprising:
a bib main body for receiving saliva of an infant;
a pocket capable of being mounted on a vertical holding seat of the infant carrier so as to cover a head protective portion of the vertical holding seat and having opening portions allowing a head support of the vertical holding seat to pass through on both sides thereof;
upper clamps for attaching both ends of an upper portion of the bib main body to an infant carrier main body of the infant carrier; and
lower clamps for attaching a lower portion of the bib main body to the infant carrier main body or the vertical holding seat selectively.
